(19) United States
(12) Patent Application Publication
(10) Pub. No.: US 2019/0190713 A1
(43) Pub. Date: Jun. 20, 2019

(54) ENCRYPTION SYSTEM, ENCRYPTION METHOD, AND COMPUTER READABLE MEDIUM

(71) Applicant: MITSUBISHI ELECTRIC CORPORATION, Tokyo (JP)

(72) Inventors: Takato HIRANO, Tokyo (JP); Yutaka KAWAI, Tokyo (JP); Goichiro HANAOKA, Tokyo (JP); Koji NUIDA, Tokyo (JP); Jacob SCHULDT, Tokyo (JP); Takahiro MATSUDA, Tokyo (JP)

(73) Assignee: MITSUBISHI ELECTRIC CORPORATION, Tokyo (JP)

(21) Appl. No.: 16/327,107

(22) PCT Filed: Aug. 7, 2017
(86) PCT No.: PCT/JP2017/028614

§ 371 Date: Feb. 21, 2019

(30) Foreign Application Priority Data
Aug. 30, 2016 (JP) 2016-168468

(51) Int. Cl. H04L 9/08; H04L 9/00; H04L 9/30; H04L 9/14

(52) U.S. Cl. CPC H04L 9/0869; H04L 9/14; H04L 9/3066; H04L 9/008

(57) ABSTRACT

A master key generation device generates a master public key and a master secret key. A user key generation device generates a user public key and a user secret key by using the master public key. An administration device acquires an arithmetic procedure. A data save unit saves data encrypted with the user public key as encryption data. The administration device selects, from the data save unit, encryption data which has been encrypted from data to be used for the arithmetic procedure. The administration device performs homomorphic operation on the encryption data based on the arithmetic procedure, and outputs the operation result of the homomorphic operation as an encryption operation result. A master decryption device acquires the encryption operation result, and decrypts the acquired encryption operation result with the master secret key.

### TECHNICAL FIELD

The present invention relates to encryption systems, encryption methods, and encryption programs. In particular, the present invention relates to an encryption system, encryption method, and encryption program for information processing by using a homomorphic technique without decrypting encryption data.

### BACKGROUND ART

Homomorphic encryption is an encryption technique capable of information processing as data is kept encrypted. Specifically, homomorphic encryption is an encryption technique capable of, by performing a special operation on ciphertexts, generating ciphertext of the operation result by using only public information without knowing plaintext. The ciphertext of the operation result is, for example, ciphertext of the sum of plaintexts of contents of each of the ciphertexts, ciphertext of the product of plaintexts of contents of each of the ciphertexts, or ciphertext of the operation result of a combination of operations such as the sum and the product. For example, as homomorphic encryption techniques as described above, there are techniques disclosed in Patent Literatures 1 and 2, Non-Patent Literatures 1 to 7, and so forth.

In recent years, with the prevalence of cloud services and so forth, data administration and data processing have become possible on the Internet. However, data administration and data processing on the Internet have a danger that a cloud server or the like entrusted with data administration could be infected with malware such as a computer virus. Moreover, there is a danger that fraud by a server administrator could cause data entrusted to the server to be leaked to the outside. This leak poses a serious problem if the data entrusted to the server is personal information or corporate confidential data.

As a method of avoiding this security threat, encryption technique can be used. However, a problem occurs in which data processing is difficult if data is simply encrypted and saved in a server. To avoid this problem, there is a known method in which data processing is performed after encryption data saved on the server is once decrypted. In this method, however, since the data is converted to plaintext in the server for a certain period, there is a possibility that the data is attacked at the moment when the encryption data is converted to plaintext to cause information leakage. Therefore, this method does not have sufficient security measures. As encryption techniques capable of solving this problem, “homomorphic encryption techniques” capable of performing operation with data being kept encrypted have been known. Many specific schemes of these “homomorphic encryption techniques” have been disclosed in recent years.

Note that the homomorphic encryption techniques are broadly classified into three types, that is, group homomorphic encryption, somewhat homomorphic encryption, and fully homomorphic encryption. Group homomorphic encryption is homomorphic encryption capable of performing only addition or multiplication, such as a well-known RSA encryption scheme and Non-Patent Literatures 1 and 2. Also, somewhat homomorphic encryption is homomorphic encryption in which both addition and multiplication can be performed but the number of times of operation execution is limited, such as Non-Patent Literatures 3 and 4. Fully homomorphic encryption is homomorphic encryption in which both addition and multiplication can be performed without limitation on the number of times of operation execution, such as Non-Patent Literatures 5 and 6.

### CITATION LIST

### Patent Literatures

Patent Literature 1: WO 2012/169153
Patent Literature 2: JP 2015-184490

### Non-Patent Literatures

Non-Patent Literature 1: P. Paillier, “Public-Key Cryptosystems Based on Composite Degree Residuosity Classes”, Eurocrypt 1999, Lecture Notes in Computer Science 1592, Springer.
Non-Patent Literature 2: E. Bresson, D. Catalano, and D. Pointcheval, “A Simple Public-Key Cryptosystems with a Double Trapdoor Decryption Mechanism and its Applications”, Asiacrypt 2003, Lecture Notes in Computer Science 2894, Springer.
Non-Patent Literature 3: D. Boneh, E-J. Goh, and K. Nissim, “Evaluating 2-DNF Formulas on Ciphertexts”, TCC 2005, Lecture Notes in Computer Science 3378, Springer.
Non-Patent Literature 4: D. Catalano and D. Fiore, “Boosting Linearly-Homomorphic Encryption to Evaluate Degree-2 Functions on Encrypted Data”, IACR Cryptology ePrint Archive: Report 2014/813.
Non-Patent Literature 5: C. Gentry, “Fully Homomorphic Encryption Using Ideal Lattices”, STOC 2009, ACM.
Non-Patent Literature 6: C. Gentry, A. Sahai, and B. Waters, “Homomorphic Encryption from Learning with Errors: Conceptually-Simpler, Asymptotically-Faster, Attribute-Based”, Crypto 2013, Lecture Notes in Computer Science 8042, Springer.
Non-Patent Literature 7: D. M. Freeman, “Converting Pairing-Based Cryptosystems from Composite-Order Groups to Prime-Order Groups”, Eurocrypto 2010, Lecture Notes in Computer Science 6110, Springer.

### SUMMARY OF INVENTION

### Technical Problem

In many existing homomorphic encryption techniques with public key encryption as a base, the public key and the secret key have a one-to-one correspondence, and therefore it is configured that one ciphertext can be decrypted by only one user. That is, when the same data is shared among n different users, n ciphertexts have to be generated by using the public key of each user, thereby posing a problem of save cost.

On the other hand, homomorphic techniques designed in consideration of this problem are disclosed in Patent Literatures 1 and 2, Non-Patent Literatures 2 and 6, and so forth. However, these techniques still have the following problems.

A technique capable of creating secret keys of two types is disclosed in Non-Patent Literature 2. Specifically in Non-Patent Literature 2, in addition to a normal pair of the public key and the secret key, a secret key capable of decrypting any ciphertext (hereinafter referred to as a master secret key) can be generated. In other words, one ciphertext can be decrypted by using the secret keys of two types. However, the technique disclosed in Non-Patent Literature 2 is a group homomorphic encryption technique capable of performing only addition. With operation only with addition, achievable processes are limited, and therefore this is not preferable in view of application. That is, the technique disclosed in Non-Patent Literature 2 has a problem in homomorphy.

A technique of reducing save cost by using a re-encryption technique is disclosed in Patent Literature 1. However, the technique disclosed in this literature is also a group homomorphic encryption technique capable of performing only addition. With operation only with addition, achievable processes are limited, and therefore this is not preferable in view of application. That is, as with Non-Patent Literature 2, the technique disclosed in Patent Literature 1 has a problem in homomorphy.

A fully homomorphic encryption technique capable of generating secret keys of many types and capable of performing both addition and multiplication is disclosed in Non-Patent Literature 6. Also, in the fully homomorphic encryption technique of Non-Patent Literature 6, unlike Non-Patent Literature 2, the authority permitting decryption on one ciphertext can be flexibly set. Also, in the fully homomorphic encryption technique of Non-Patent Literature 6, data processing of various types can be performed with data kept in a state of being encrypted. However, the technique disclosed in this literature takes a technique called lattice encryption as a base. In this lattice encryption, process cost in encryption, the size of ciphertext, and the key size are significantly large, compared with well-known public key encryption techniques such as RSA encryption. Thus, the fully homomorphic encryption technique of Non-Patent Literature 6 is not preferable in efficiency of encryption. That is, the technique disclosed in Non-Patent Literature 6 has a problem in view of practical cost.

A technique of reducing save cost by using encrypted auxiliary information and a re-encryption technique is disclosed in Patent Literature 2. However, the technique disclosed in this literature also takes a technique using lattice encryption as a base, and is not preferable in efficiency. That is, as with Non-Patent Literature 6, the technique disclosed in Patent Literature 2 has a problem in view of practical cost.

In the above-described conventional techniques except Non-Patent Literature 2, the master public key and the master secret key are both used to generate the user public key and the user secret key, thereby posing a problem of higher operation cost.

An object of the present invention is to provide a homomorphic encryption technique with high homomorphy such as somewhat homomorphic encryption or fully homomorphic encryption and efficient processing capability while reducing operation cost and save cost.

### Solution to Problem

An encryption system according to the present invention includes:

a master key generation device to generate a public key and a secret key for a first user as a master public key and a master secret key;

a user key generation device to generate a public key and a secret key for a second user as a user public key and a user secret key by using the master public key;

an administration device including a data save unit to save encryption data encrypted with the user public key and an arithmetic operation unit to acquire a procedure of operation using data as an arithmetic procedure, to select encryption data which has been encrypted from data for use in the arithmetic procedure, from the data save unit, to perform homomorphic operation on the encryption data based on the arithmetic procedure, and to output an operation result of the homomorphic operation as an encryption operation result; and

a master decryption device to acquire the encryption operation result and to decrypt the acquired encryption operation result with the master secret key.

### Advantageous Effects of Invention

In the encryption system according to the present invention, the user key generation device generates the user public key and the user secret key by using only the master public key without using the master secret key. Also, the arithmetic operation unit of the administration device acquires the procedure of operation using data as the arithmetic procedure, and selects encryption data which has been encrypted from the data to be used for the arithmetic procedure, from the data save unit. Furthermore, the arithmetic operation unit of the administration device performs homomorphic operation on the encryption data based on the arithmetic procedure and outputs the encryption operation result. The master decryption device then acquires the encryption operation result, and decrypts the encryption operation result with the master secret key. Thus, an encryption system with efficient processing capability while reducing operation cost and save cost can be provided.

### BRIEF DESCRIPTION OF DRAWINGS

FIG. 1 is a diagram of the structure of an encryption system 100 according to Embodiment 1.

FIG. 2 is a diagram of the structure of a master key generation device 200 according to Embodiment 1.

FIG. 3 is a diagram of the structure of a user key generation device 300 according to Embodiment 1.

FIG. 4 is a diagram of the structure of an encryption device 400 according to Embodiment 1.

FIG. 5 is a diagram of the structure of a master decryption device 500 according to Embodiment 1.

FIG. 6 is a diagram of the structure of a user decryption device 600 according to Embodiment 1.

FIG. 7 is a diagram of an administration device 700 according to Embodiment 1.

FIG. 8 is a flowchart illustrating a master key pair generation and save process of the encryption system 100 according to Embodiment 1.

FIG. 9 is a flowchart illustrating a user key pair generation and save process of the encryption system 100 according to Embodiment 1.

FIG. 10 is a flowchart illustrating a data encryption and save process of the encryption system 100 according to Embodiment 1.

FIG. 11 is a flowchart illustrating a master decryption process S30 of the encryption system 100 according to Embodiment 1.

FIG. 12 is a flowchart illustrating a user decryption process S40, which is a data decryption process for a user, of the encryption system 100 according to Embodiment 1.

FIG. 13 is a flowchart illustrating a homomorphic operation process S50 and an operation result decryption process S60 of the encryption system 100 according to Embodiment 1.

FIG. 14 is a flowchart illustrating a homomorphic operation process S50 and an operation result decryption process S60 of the encryption system 100 according to Embodiment 1.

FIG. 15 is a diagram of the structure of a master key generation device 200 according to a modification example of Embodiment 1.

FIG. 16 is a diagram of the structure of a user key generation device 300 according to the modification example of Embodiment 1.

FIG. 17 is a diagram of the structure of an encryption device 400 according to the modification example of Embodiment 1.

FIG. 18 is a diagram of the structure of a master decryption device 500 according to the modification example of Embodiment 1.

FIG. 19 is a diagram of the structure of a user decryption device 600 according to the modification example of Embodiment 1.

FIG. 20 is a diagram of the structure of an administration device 700 according to the modification example of Embodiment 1.

### DESCRIPTION OF EMBODIMENT

In the following, an embodiment of the present invention is described by using the drawings. Note that identical or relevant portions in the respective drawings are provided with the same reference character. In the description of the embodiment, description of identical or relevant portions is omitted or simplified as appropriate.

### Embodiment 1

***Description of Structure***

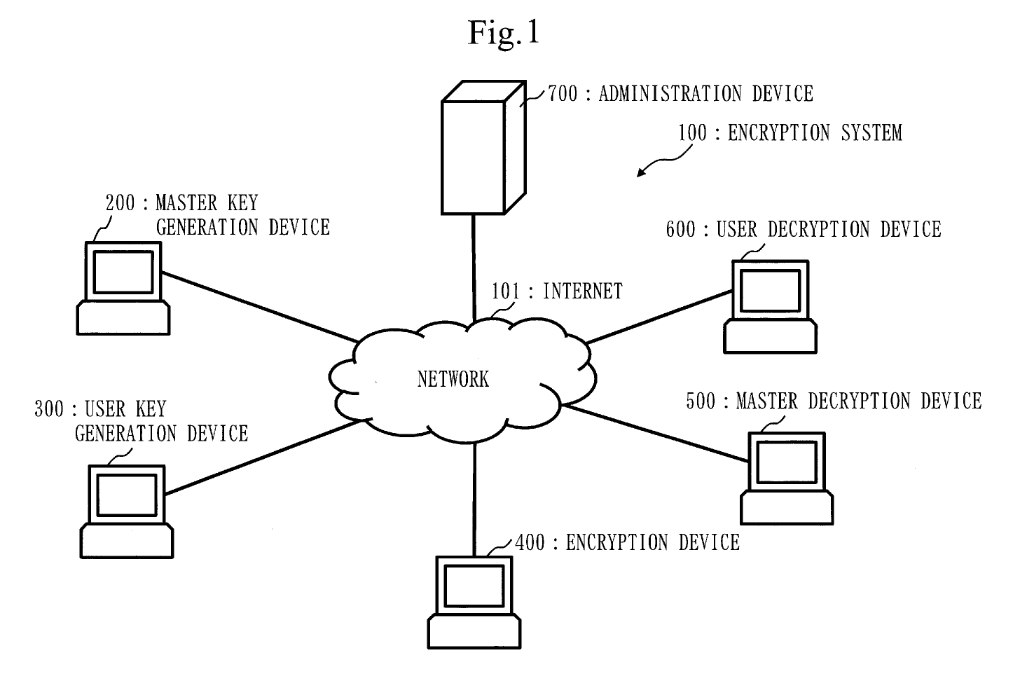

The structure of an encryption system 100 according to the present embodiment is described by using FIG. 1.

A somewhat homomorphic encryption technique capable of performing addition desired times and performing multiplication once is disclosed in the present embodiment.

As illustrated in FIG. 1, the encryption system 100 includes a master key generation device 200, a user key generation device 300, an encryption device 400, a master decryption device 500, a user decryption device 600, and an administration device 700. The encryption system 100 may include a plurality of master key generation devices 200. The encryption system 100 may include a plurality of user key generation devices 300. The encryption system 100 may include a plurality of encryption devices 400. The encryption system 100 may include a plurality of master decryption devices 500. The encryption system 100 may include a plurality of user decryption devices 600. The encryption system 100 may include a plurality of administration device 700.

In FIG. 1, in the encryption system 100, the master key generation device 200, the user key generation device 300, the encryption device 400, the master decryption device 500, the user decryption device 600, and the administration device 700 are connected via the Internet 101. However, the structure may not be such that the respective devices in the encryption system 100 are connected one another via the Internet 101. Each device in the encryption system 100 may be installed inside a LAN (Local Area Network) laid in the same business enterprise.

The Internet 101 is a communication path for connecting the master key generation device 200, the user key generation device 300, the encryption device 400, the master decryption device 500, the user decryption device 600, and the administration device 700. The Internet 101 is an example of a network. In place of the Internet 101, a network of another type may be used.

The master key generation device 200 generates a public key and a secret key for an administrator of the encryption system 100 as a master public key and a master secret key. The master key generation device 200 generates a pair of a master public key and a master secret key (hereinafter referred to as a master key pair). The master key pair is used for encryption or decryption for the administrator of the present system. The master key generation device 200 is a device which transmits the master public key to the user key generation device 300, the encryption device 400, and the administration device 700 via the Internet 101. Also, the master key generation device 200 is a device which transmits the master key pair to the master decryption device 500 via the Internet 101. Note that this master public key or master key pair may be transmitted not via the Internet 101 but directly via a recording medium, by mail, or the like.

The user key generation device 300 generates a public key and a secret key for a user of the present system as a user public key and a user secret key by using the master public key. The user key generation device 300 generates a pair of a user public key and a user secret key (hereinafter referred to as a user key pair). The user key pair is used for encryption or decryption for the user of the present system. The user key generation device 300 is a device which transmits the user public key to the encryption device 400 and the administration device 700 via the Internet 101. Also, the user key generation device 300 is a device which transmits the user key pair to the user decryption device 600 via the Internet 101. Note that this user public key or user key pair may be transmitted not via the Internet 101 but directly via a recording medium, by mail, or the like.

Here, the administrator of the encryption system 100 is a special user having the power permitted to decrypt ciphertext of all users. The administrator of the present system is an example of a first user.

On the other hand, unlike the administrator, the user of the encryption system 100 is not permitted to decrypt ciphertext of other users and is permitted to decrypt ciphertext encrypted with a public key corresponding to the user itself. The user of the present system is an example of a second user.

Note that homomorphic operation can be performed in any device with the master public key or the public key of each user. However, to decrypt ciphertext after homomorphic operation, the master secret key or the user secret key of each user is required.

The encryption device 400 acquires data to be encrypted, and encrypts the acquired data with the user public key. The encryption device 400 then transmits the encrypted data as encryption data to the administration device 700. The encryption device 400 is a device which encrypts the data and generates ciphertext (hereinafter referred to as encryption data) by using the master public key or the user public key and saves the encryption data in the administration device 700.

The master decryption device 500 is a device which decrypts, by using the master key pair, ciphertext registered in the administration device 700 or the like and extracts plaintext.

Also, the master decryption device 500 issues a request for performing homomorphic operation on ciphertext registered in the administration device 700. And, the master decryption device 500 is a device which decrypts, by using the master key pair, ciphertext of the homomorphic operation result (hereinafter referred to as encryption operation result) and extracts the operation result of plaintext.

The user decryption device 600 is a device which decrypts, by using the user key pair, ciphertext registered in the administration device 700 or the like and extracts plaintext.

Also, the user decryption device 600 issues a request for performing homomorphic operation on ciphertext registered in the administration device 700. And, the user decryption device 600 is a device which decrypts, by using the user key pair, ciphertext of the homomorphic operation result (that is, the encryption operation result) and extracts the operation result of plaintext.

The administration device 700 is a device which has a large-capacity recording medium for saving encryption data generated by the encryption device 400.

The administration device 700 functions as a save device. That is, when a request for saving encryption data comes from the encryption device 400, the administration device 700 saves the encryption data.

Also, the administration device 700 functions as an arithmetic device. That is, when a request for homomorphic operation on encryption data saved in the administration device 700 comes from the master decryption device 500 or the user decryption device 600, the administration device 700 performs homomorphic operation on the specified encryption data. The administration device 700 then transmits the encryption operation result to the master decryption device 500 or the user decryption device 600.

Next, description is made to the structure of each of the master key generation device 200, the user key generation device 300, the encryption device 400, the master decryption device 500, the user decryption device 600, and the administration device 700 included in the encryption system 100. In the following description, every device of the master key generation device 200, the user key generation device 300, the encryption device 400, the master decryption device 500, the user decryption device 600, and the administration device 700 included in the encryption system 100 may be referred to as a device included in the encryption system 100. Also, the devices included in the encryption system 100 may be each referred to as each device.

In the following, pieces of hardware having a common function in the device included in the encryption system 100 are provided with the same reference numeral.

<Master Key Generation Device 200>

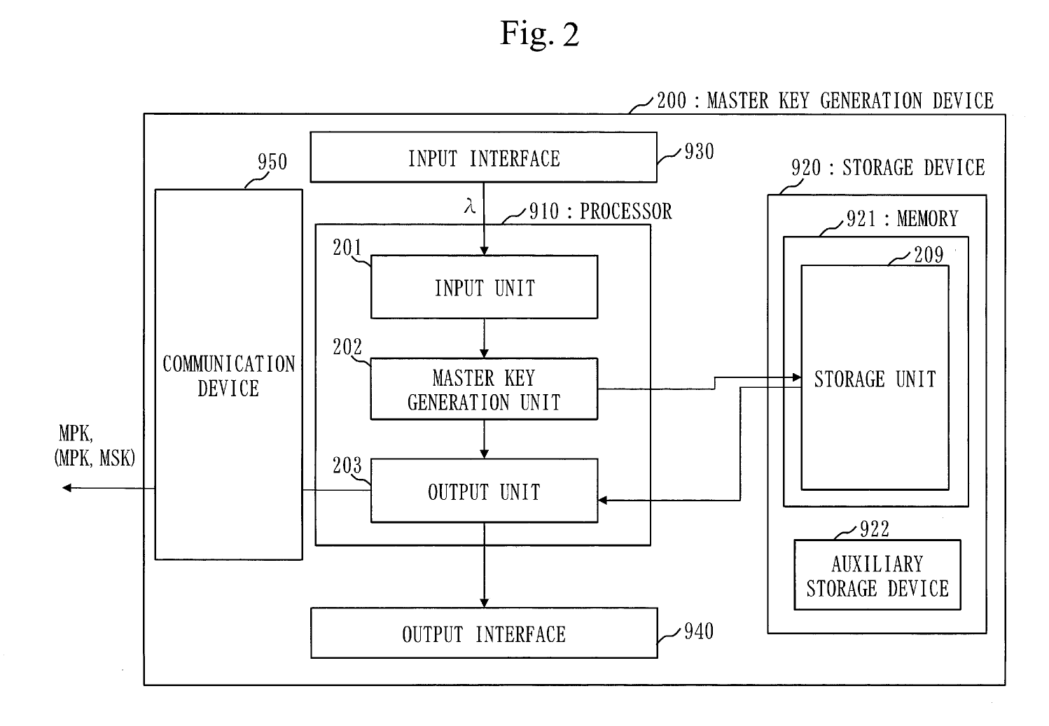

The structure of the master key generation device 200 according to the present embodiment is described by using FIG. 2.

The master key generation device 200 is a computer. The master key generation device 200 includes a processor 910 and other hardware such as a storage device 920, an input interface 930, an output interface 940, and a communication device 950. The storage device 920 has a memory 921 and an auxiliary storage device 922.

As illustrated in FIG. 2, the master key generation device 200 includes, as functional structures, an input unit 201, a master key generation unit 202, an output unit 203, and a storage unit 209.

In the following description, the functions of the input unit 201, the master key generation unit 202, and the output unit 203 in the master key generation device 200 are referred to as functions of “units” of the master key generation device 200.

The functions of the “units” of the master key generation device 200 are implemented by software.

The storage unit 209 is implemented by the storage device 920.

The input unit 201 receives a security parameter λ indicating encryption strength from the administrator via the input interface 930.

The master key generation unit 202 generates, based on the security parameter λ received from the input unit 201, a master key pair (MPK, MSK) formed of a master public key MPK and a master secret key MSK. The master key generation unit 202 generates the master public key MPK and the master secret key MSK by using a generator g configuring a cyclic group on an elliptic curve capable of calculating a pairing map.

Specifically, the master public key MPK and the master secret key MSK are generated by using the method described in Non-Patent Literature 3 or the like. The master key generation unit 202 randomly generates a prime number p and a prime number q of λ/2 bits. Also, the master key generation unit 202 finds the generator g configuring a cyclic group G_N of an order N on an elliptic curve capable of efficiently calculating a bilinear map e (also referred to as a pairing map). Note that the bilinear map e is a map defined as G_N×G_N→G_N′, and G_N′ is a cyclic group of the order N. In the following, operation on G_N is represented by *, and operation on G_N′ is represented by ⋅. Also, exponential operation is represented by ̂. The master key generation unit 202 finds h=ĝ(αq) configuring a partial cyclic group G_p of the cyclic group G_N, where α is assumed to be an integer randomly selected from a set of integers {1, . . . , p}. Here, it is set that MPK=(N, e, g, h) and MSK=(p, q).

The output unit 203 transmits the master public key MPK generated at the master key generation unit 202 via the communication device 950 to the user key generation device 300, the encryption device 400, and the administration device 700. Also, the output unit 203 transmits the master key pair (MSK, MSK) generated at the master key generation unit 202 via the communication device 950 to the master decryption device 500. That is, the master key generation device 200 transmits the master public key MPK and the master secret key MSK to the master decryption device 500, and also transmits only the master public key MPK to the user key generation device 300, the encryption device 400, and the administration device 700.

<User Key Generation Device 300>

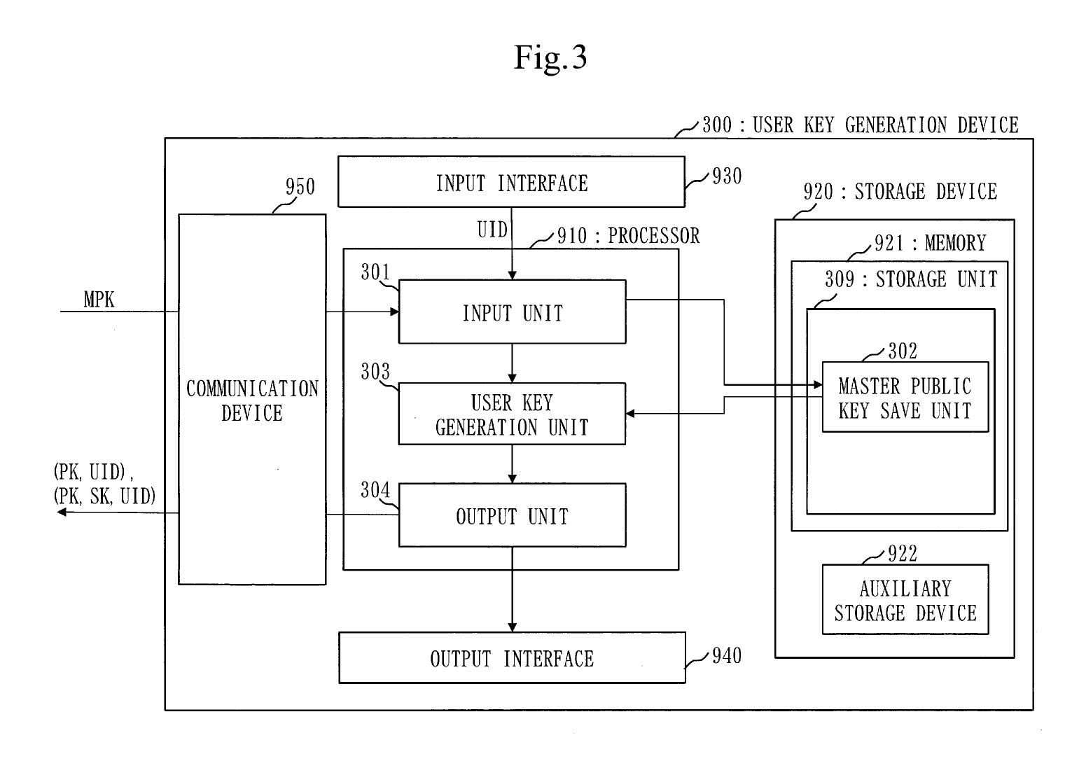

The structure of the user key generation device 300 according to the present embodiment is described by using FIG. 3.

The user key generation device 300 is a computer. The master key generation device 200 includes a processor 910 and other hardware such as a storage device 920, an input interface 930, an output interface 940, and a communication device 950. The storage device 920 has a memory 921 and an auxiliary storage device 922.

As illustrated in FIG. 3, the user key generation device 300 has, as functional structures, an input unit 301, a user key generation unit 303, an output unit 304, and a storage unit 309. The storage unit 309 has a master public key save unit 302.

In the following description, the functions of the input unit 301, the user key generation unit 303, and the output unit 304 in the user key generation device 300 are referred to as functions of “units” of the user key generation device 300.

The functions of the “units” of the user key generation device 300 are implemented by software.

The storage unit 309 is implemented by the storage device 920.

The input unit 301 receives, via the communication device 950, the master public key MPK generated at the master key generation device 200.

Also, the input unit 301 receives, from the user via the input interface 930, a user identifier UID for identifying that user. A specific example of the user identifier is a name of the user, a name of an organization the user belongs to, or an identification number successively and uniquely allocated in the system. This is used to indicate which user the user public key is associated with or which user the ciphertext is associated with.

The master public key save unit 302 saves the master public key MPK received from the input unit 301.

The user key generation unit 303 generates the user public key PK and the user secret key SK by using the master public key MPK and the randomly selected natural number. The user key generation unit 303 generates a user key pair (PK, SK) formed of the user public key PK and the user secret key SK by using the user identifier UID received from the input unit 301 and the master public key MPK read from the master public key save unit 302.

Specifically, the user key generation unit 303 finds y=ĥx by using the master public key MPK, where x is a natural number randomly selected from a set of integers {1, . . . , N}. Here, it is set that PK=(N, e, g, h, y) and SK=x.

The output unit 304 outputs a pair of the user public key generated at the user key generation unit 303 and the user identifier, (PK, UID), for transmission via the communication device 950 to the encryption device 400 and the administration device 700. Also, the output unit 304 outputs a set of the user key pair (PK, SK) generated at the user key generation unit 303 and the user identifier UID, (PK, SK, UID), for transmission via the communication device 950 to the user decryption device 600. That is, the user key generation device 300 transmits the user public key PK and the user secret key SK to the user decryption device 600 and also transmits only the user public key PK to the encryption device 400 and the administration device 700.

<Encryption Device 400>

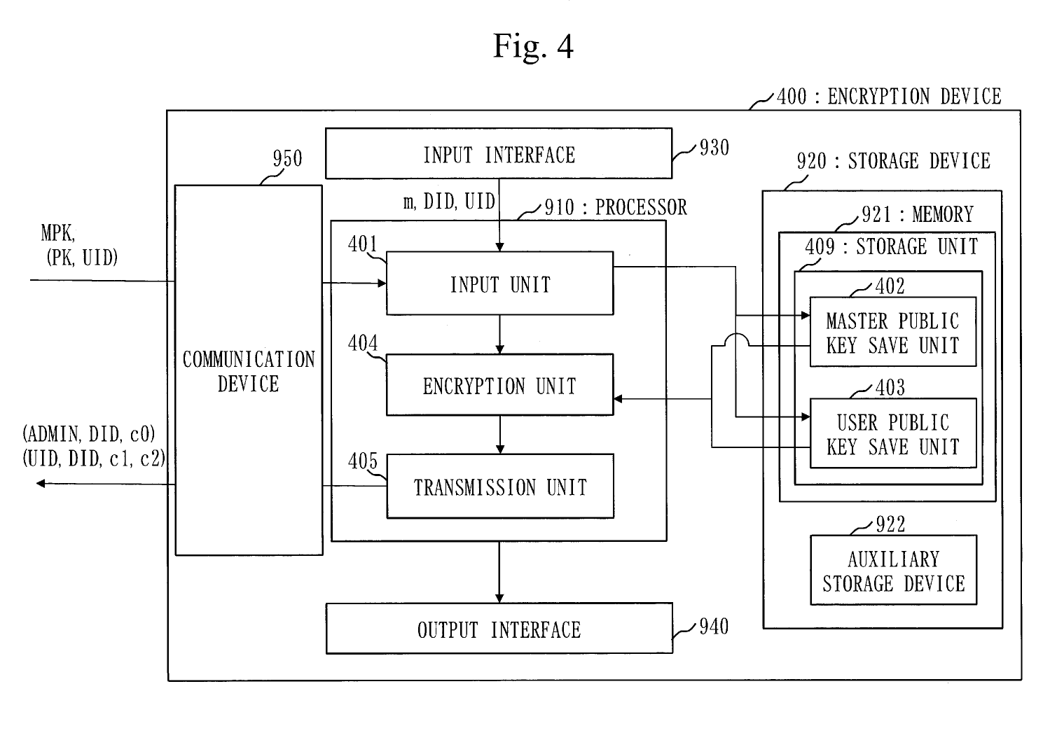

The structure of the encryption device 400 according to the present embodiment is described by using FIG. 4.

The encryption device 400 is a computer. The encryption device 400 includes a processor 910 and other hardware such as a storage device 920, an input interface 930, an output interface 940, and a communication device 950. The storage device 920 has a memory 921 and an auxiliary storage device 922.

As illustrated in FIG. 4, the encryption device 400 includes, as function structures, an input unit 401, an encryption unit 404, a transmission unit 405, and a storage unit 409. The storage unit 409 has a master public key save unit 402 and a user public key save unit 403.

In the following description, the functions of the input unit 401, the encryption unit 404, and the transmission unit 405 in the encryption device 400 are referred to as functions of “units” of the encryption device 400.

The functions of the “units” of the encryption device 400 are implemented by software.

The storage unit 409 is implemented by the storage device 920.

The input unit 401 receives, via the communication device 950, the master public key MPK generated at the master key generation device 200 or the pair of the user public key and the user identifier, (PK, UID), generated at the user key generation device 300.

The input unit 401 receives, from the user via the input interface 930, data m to be encrypted, a data identifier DID for identifying that data, and the user identifier UID of the user to which encryption data is to be passed. A specific example of the data identifier DID is a name of the data or an identification number successively and uniquely allocated in the system. This data identifier DID is used to identify ciphertext as a target to be decrypted or a target for use in homomorphic operation. Also, the data m is assumed to be data having a bit length on the order capable of a solving a discrete logarithm problem. For example, the bit length of the data m is on the order of log_2(λ).

The master public key save unit 402 saves the master public key MPK received from the input unit 401.

The user public key save unit 403 saves the pair of the user public key received from the input unit 401 and the user identifier, (PK, UID).

The encryption unit 404 reads the master public key MPK from the master public key save unit 402, encrypts the data m received from the input unit 401, and generates encryption data c0.

Specifically, the encryption unit 404 randomly selects r from the set of integers {1, . . . , N}, and calculates c0 by using the master public key MPK with the following expression (1).

c0=ŷr*ĝm (1)

The encryption unit 404 reads, from the user public key save unit 403, the pair of the user public key and the user identifier, (PK, UID), corresponding to the user identifier UID received from the input unit 401, encrypts the data m received from the input unit 401, and generates encryption data (c1, c2).

Specifically, the encryption unit 404 randomly selects r from the set of integers {1, . . . , N}, and calculates c1 and c2 by using the user public key PK with the following expression (2) and expression (3).

c1=ĥr (2),

c2=ŷr*ĝm (3)

The transmission unit 405 outputs a set of the user identifier UID representing the administrator (hereinafter represented as ADMIN), the data identifier DID, and the data encryption data c0 received from the encryption unit 404, (ADMIN, DID, c0), for transmission to the administration device 700.

The transmission unit 405 outputs a set of the user identifier UID, the data identifier DID, and the encryption data (c1, c2) received from the encryption unit 404, (UID, DID, c1, c2), for transmission to the administration device 700.

That is, the encryption device 400 acquires the data m to be encrypted and the user identifier for identifying the user, and transmits the encryption data with the data m encrypted and the user identifier to the administration device 700.

<Master Decryption Device 500>

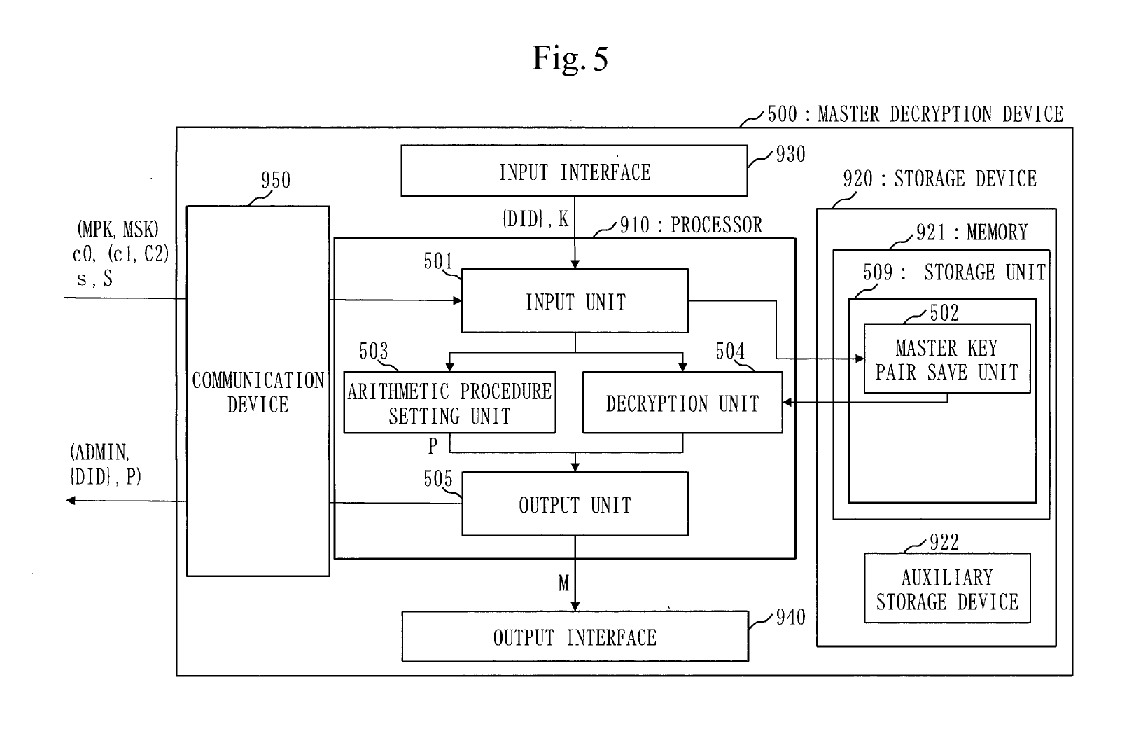

The structure of the master decryption device 500 according to the present embodiment is described by using FIG. 5.

The master decryption device 500 is a computer. The master decryption device 500 includes a processor 910 and other pieces of hardware including a storage device 920, an input interface 930, an output interface 940, and a communication device 950. The storage device 920 has a memory 921 and an auxiliary storage device 922.

As illustrated in FIG. 5, the master decryption device 500 includes, as functional structures, an input unit 501, an arithmetic procedure setting unit 503, a decryption unit 504, an output unit 505, and a storage unit 509. The storage unit 509 has a master key pair save unit 502.

In the following description, the functions of the input unit 501, the arithmetic procedure setting unit 503, the decryption unit 504, and the output unit 505 in the master decryption device 500 are referred to as functions of “units” of the master decryption device 500.

The functions of the “units” of the master decryption device 500 are implemented by software.

The storage unit 509 is implemented by the storage device 920.

The input unit 501 receives, via the communication device 950, the master key pair (MPK, MSK) generated at the master key generation device 200.

The input unit 501 receives, from the administrator via the input interface 930, a data identifier set {DID1, . . . , DIDn} for identifying data as a target for homomorphic operation in the encryption data saved in the administration device 700 and a process description K indicating how the target data is to be processed, where n is an integer equal to or larger than 1. From this onward, the data identifier set {DID1, . . . , DIDn} is abbreviated as {DID}. For example, this process description K is, by way of example, a “total sum” or “Euclidean square distance” of two pieces of data, or the like. Alternatively, the process description K may be a specific arithmetic procedure itself, such as homomorphic addition of which data and which data.

The input unit 501 receives the encryption data saved in the administration device 700 or the like or the encryption operation result (homomorphic operation result) processed by the administration device 700.

The master key pair save unit 502 saves the master key pair (MPK, MSK) received from the input unit 501. Note that to strictly administer this master key pair, (MPK, MSK) is saved as encrypted. Alternatively, alternatively, the master key pair save unit 502 may protect the master key pair so as to allow (MPK, MSK) to be read after authenticating the administrator by using a password, token, biological information, or the like.

The arithmetic procedure setting unit 503 generates, from the data identifier set {DID} and the process description K received from the input unit 501, an arithmetic procedure P, which is a procedure of operation using data, such as which encryption data a homomorphic operation is to be performed on. The arithmetic procedure P has a specific homomorphic operation procedure described therein. As described above, the arithmetic procedure P may be an arithmetic procedure including multiplication such as “Euclidean square distance”. For example, when the process description K indicates a “total sum”, the arithmetic procedure is set so that homomorphic addition is performed on all pieces of encryption data corresponding to the data identifier set. If the process description K already indicates a specific homomorphic operation procedure, that process description K may be set as the arithmetic procedure P. Also, this procedure may be determined by the system in advance and the administrator may select the determined procedure.

The decryption unit 504 reads the master key pair (MPK, MSK) from the master key pair save unit 502, decrypts the encryption data received from the input unit 501 or the encryption operation result, and finds data M as the operation result of plaintext.

Specifically, the decryption unit 504 calculates Mp=c0̂p and b_p=ĝp on the encryption data c0 encrypted with the public key of the administrator by using the master key pair, and calculates a discrete logarithm M for M_p with b_p as a base. To calculate this M, for example, the λ method described in Non-Patent Literature 3 or the like can be used. In the following, to represent finding of a discrete logarithm, representation is made by using DLog such as M=DLog_(b_p)(M_p). If the ciphertext data (c1, c2) encrypted with the user public key is decrypted, c2 may be taken as c0 and a process similar to the above may be performed.

Also, if the encryption operation result is represented by one element s on G_N, the decryption unit 504 finds the data M by using the master key pair and performing a decryption process similar to the above by assuming s=c0. If the encryption operation result is represented by one element S on G′_N, the decryption unit 504 finds the data M by performing calculation as in the following expression (4).

M=D Log_(e(g,g)̂p)(Ŝp) (4)

Note that a specific structure of s or S of the encryption operation result will be described further below.

The output unit 505 outputs a set of the user identifier ADMIN representing the administrator and the data identifier set {DID} and the arithmetic procedure P received from the arithmetic procedure setting unit 503, (ADMIN, {DID}, P). The output unit 505 transmits the set (ADMIN, {DID}, P) to the administration device 700 via the communication device 950.

The output unit 505 outputs the data M received from the decryption unit 504 via the output interface 940.

<User Decryption Device 600>

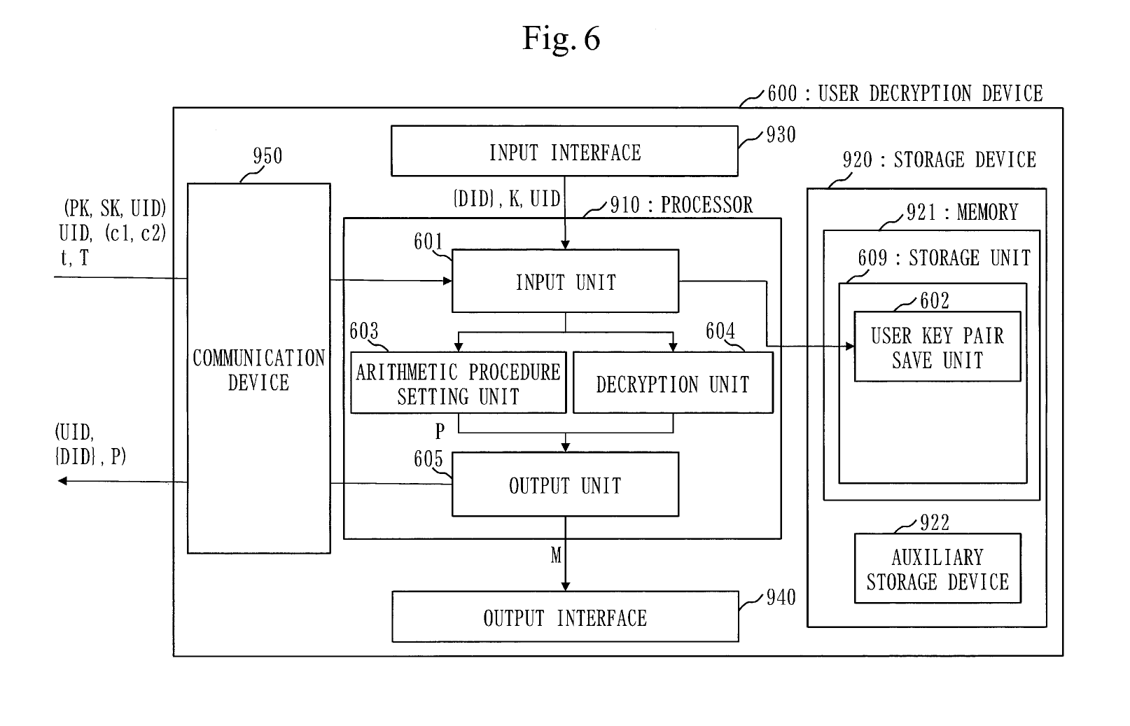

The structure of the user decryption device 600 according to the present embodiment is described by using FIG. 6.

The user decryption device 600 is a computer. The user decryption device 600 includes a processor 910 and other hardware such as a storage device 920, an input interface 930, an output interface 940, and a communication device 950. The storage device 920 has a memory 921 and an auxiliary storage device 922.

As illustrated in FIG. 6, the user decryption device 600 includes, as functional structures, an input unit 601, an arithmetic procedure setting unit 603, a decryption unit 604, an output unit 605, and a storage unit 609. The storage unit 609 has a user key pair save unit 602.

In the following description, the functions of the input unit 601, the arithmetic procedure setting unit 603, the decryption unit 604, and the output unit 605 in the user decryption device 600 are referred to as functions of “units” of the user decryption device 600.

The functions of the “units” of the user decryption device 600 are implemented by software.

The storage unit 609 is implemented by the storage device 920.

The input unit 601 receives the set of the user key pair generated at the user key generation device 300 and the user identifier, (PK, SK, UID), via the communication device 950.

The input unit 601 receives, from the user via the input interface 930, the user identifier UID, a data identifier set {DID1, . . . , DIDn} for identifying data as a target for homomorphic operation in the encryption data saved in the administration device 700, and a process description K indicating how the data as the target for homomorphic operation is to be processed, where n is an integer equal to or larger than 1. From this onward, the data identifier set {DID1, . . . , DIDn} is abbreviated as {DID}.

The input unit 601 receives the encryption data saved in the administration device 700 or the like or the encryption operation result (homomorphic operation result) processed by the administration device 700.

The user key pair save unit 602 saves the set of the user key pair and the user identifier, (PK, SK, UID), received from the input unit 601. Note that to strictly administer this user key pair, the user key pair save unit 602 encrypts and saves (PK, SK). Alternatively, the user key pair save unit 602 may protect the user key pair so as to allow (PK, SK) to be read after authenticating the true user by using a password, token, biological information, or the like.

The arithmetic procedure setting unit 603 generates, from the process description K, the data identifier set {DID}, and the user identifier UID received from the input unit 601, an arithmetic procedure P having a specific homomorphic operation procedure described therein, such as which encryption data a homomorphic operation is to be performed on. If the process description K already indicates a specific homomorphic operation procedure, that process description K may be set as the arithmetic procedure P. Also, as described above, this procedure may be determined by the system in advance and the user may select the determined procedure.

The decryption unit 604 reads the user key pair (PK, SK, UID) from the user key pair save unit 602. The decryption unit 604 decrypts the encryption data (c1, c2) received from the input unit 601 or the encryption operation result by using the user key pair (PK, SK, UID), and generates data M.

Specifically, the decryption unit 604 finds the data M for the encryption data (c1, c2) by using the user key pair as in the following expression (5).

M=D Log_(g)(c1̂(−x)*c2) (5)

Also, if the encryption operation result is represented by an element pair (t1, t2) (t1, and t2 may be simply represented as t) on G_N, the decryption unit 604 finds the data M by using the user key pair and performing a decryption process similar to the above by assuming (t1, t2)=(c1, c2). If the encryption operation result is represented by an element set (T1, T2, T3) (T1, T2, and T3 may be simply represented as T) on G_N′, the decryption unit 604 finds the data M by performing calculation by using the user key pair as in the following expression (6).

M=D Log_(e(g,g))(T1̂(−x̂2)·T2̂(x)·T3) (6)

The output unit 605 outputs a set of the user identifier UID and the data identifier set {DID} and the arithmetic procedure P received from the arithmetic procedure setting unit 503, (UID, {DID}, P), for transmission to the administration device 700. The output unit 605 outputs the user identifier UID, the data identifier set {DID}, and the arithmetic procedure P received from the arithmetic procedure setting unit 603, and transmits a set thereof, (UID, {DID}, P), via the communication device 950 to the administration device 700.

The output unit 605 outputs, via the output interface 940, the data M received from the decryption unit 604.

<Administration Device 700>

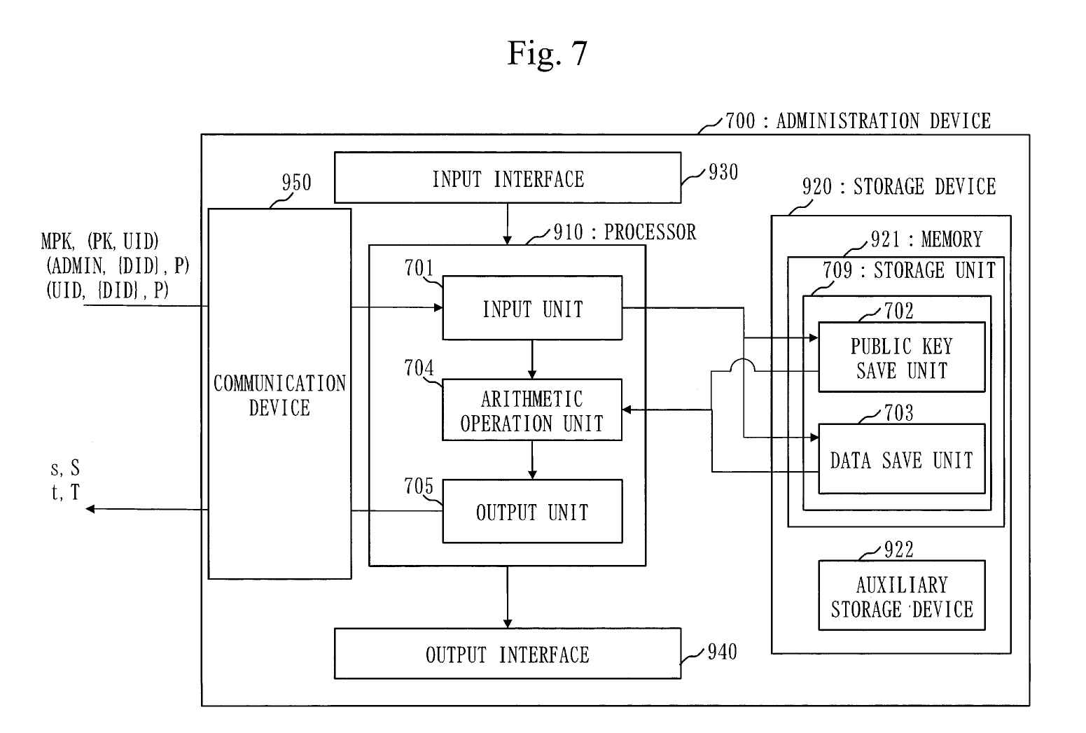

The structure of the administration device 700 according to the present embodiment is described by using FIG. 7.

The administration device 700 is a computer. The administration device 700 includes a processor 910 and other hardware such as a storage device 920, an input interface 930, an output interface 940, and a communication device 950. The storage device 920 has a memory 921 and an auxiliary storage device 922.

As illustrated in FIG. 7, the administration device 700 includes, as functional structures, an input unit 701, an arithmetic operation unit 704, an output unit 705, and a storage unit 709. The storage unit 709 has a public key save unit 702 and a data save unit 703.

In the following description, the functions of the input unit 701, the arithmetic operation unit 704, and the output unit 705 in the administration device 700 are referred to as functions of “units” of the administration device 700.

The functions of the “units” of the administration device 700 are implemented by software.

The storage unit 709 is implemented by the storage device 920.

The input unit 701 receives, via the communication device 950, the master public key MPK generated at the master key generation device 200 or the pair of the user public key and the user identifier, (PK, UID), generated at the user key generation device 300.

The input unit 701 receives, via the communication device 950, the set of the user identifier, the data identifier, and the encryption data, (ADMIN, DID, c0) or (UID, DID, c1, c2), generated at the encryption device 400.

The input unit 701 receives, via the communication device 950, the set of the user identifier, the data identifier set, and the arithmetic procedure (ADMIN, {DID}, P) generated at the master decryption device 500 or the set of the user identifier, the data identifier set, and the arithmetic procedure, (UID, {DID}, P), generated at the user decryption device 600.

The public key save unit 702 saves the master public key MPK or the pair of the user public key and the user identifier, (PK, UID), received from the input unit 701.

The data save unit 703 saves data encrypted with the master public key PK or the user public key PK as encryption data (c0 or (c1, c2)). The data save unit 703 stores the encryption data and the user identifier (ADMIN or UID) in association with each other. Specifically, the data save unit 703 saves a set of the user identifier, the data identifier, and the encryption data, (ADMIN, DID, c0) or (UID, DID, c1, c2), received from the input unit 701.

The arithmetic operation unit 704 selects, from the data save unit 703, the encryption data (c0 or (c1, c2)) which has been encrypted from the data for use in the arithmetic procedure P. The arithmetic operation unit 704 acquires the arithmetic procedure P and a first user identifier (ADMIN), which is a user identifier of the administrator, and selects, from the data save unit 703, encryption data which has been encrypted from data for use in the arithmetic procedure P and being associated with the first user identifier (ADMIN). Also, the arithmetic operation unit 704 acquires the arithmetic procedure P and a second user identifier (UID), which is a user identifier of the user, and selects, from the data save unit 703, encryption data which has been encrypted from the data for use in the arithmetic procedure P and being associated with the second user identifier (UID). The arithmetic operation unit 704 performs homomorphic operation on the selected encryption data based on the arithmetic procedure P, and outputs the operation result of the homomorphic operation as the encryption operation result.

Specifically, the arithmetic operation unit 704 reads the master public key MPK from the public key save unit 702, or the set (ADMIN, DID, c0) or (UID, DID, c1, c2) having the data identifier DID included in {DID} from the data save unit 703, by using (ADMIN, {DID}, P) or (UID, {DID}, P) received from the input unit 701. The arithmetic operation unit 704 then performs homomorphic process on the encryption data c0 or the set (c1, c2) by following the arithmetic procedure P, and generates the encryption operation result.

Specifically, when homomorphic addition is performed on two pieces of encryption data (c1, c2)=(ĝr, ŷr*ĝm) and (c1′, c2′)=(ĝ(r′), ŷ(r′)*ĝ(m′)), calculation is performed as in the following expression (7) and expression (8), and encryption data (c1″, c2″) of new m+m′ is found, where r″ is assumed to be an integer randomly selected from among the set of integers {1, . . . , N}.

c1″=c1*c1′*ĥ(r″)=ĥ(r+r′+r″) (7)

c2″=c2*c2′*ŷ(r″)=ŷ(r+r′+r″)*ĝ(m+m′) (8)

Note that on the encryption data (c1″, c2″) of this homomorphic addition result, homomorphic addition can be further performed or homomorphic multiplication, which will be described below, can be performed.

When homomorphic multiplication of (c1, c2) and (c1′, c2′) is performed, calculation is made as in the following expression (9) to expression (11), and encryption data (C1, C2, C3) of new m×m′ is found, where r1 and r2 are assumed to be integers randomly selected from the set of integers {1, . . . , N} and it is set that R1=rr′+r1 and R2=−rm′+r′m+r2.

C1=e(c1,c1′)·e(h,h)̂r1=e(h,h)̂R1 (9)

C2=e(c1,c2′̂(−1))·e(c1′,c2)·e(h,g)̂r2=e(h,g)̂R2 (10)

C3=e(c2,c2′)·e(h,h)̂r1·e(y,g)̂r2=e(y,y)̂R1·e(y,g)̂(−R2)·e(g,g)̂(m×m′) (11)

Note that for the encryption data (C1, C2, C3) of this homomorphic multiplication result, homomorphic addition can be further performed as described below, but executing homomorphic multiplication is difficult.

When homomorphic addition is performed on the encryption data after homomorphic multiplication, (C1, C2, C3)=(e(h, h)̂R1, e(h, g)̂R2, e(y, y)̂R1·e(y, g)̂(−R2)·e(c2, c2′)̂m) and (C1′, C2′, C3′)=(e(h, h)̂R1′, e(h, g)̂R2′, e(y, y)̂R1′·e(y, g)̂(−R2′)·e(g, g)̂m′), encryption data (C1″, C2″, C3″) of new m+m′ is found as in the following expression (12) to expression (14), where R and R′ are assumed to be integers randomly selected from among a set of integers {1, . . . , N} and it is set that R1″=R1+R1′+R and R2″=R2+R2′+R′.

C1″=C1·C1′·e(h,h)̂R=e(h,h)̂R1″ (12)

C2″=C2·C2′·e(h,g)̂R′=e(h,g)̂R2″ (13)

C3″=C3·C3″·e(y,y)̂R·e(y,g)̂(−R′)=e(y,y)_{̂R}1″·e(y,g)_{̂R2″·e}(g,g)̂(m+m′) (14)

Note that while homomorphic addition can be further performed on the encryption data (C1″, C2″, C3″) of this homomorphic multiplication result but executing homomorphic multiplication is difficult.

The arithmetic operation unit 704 performs calculation on a plurality of pieces of encryption data in combination with homomorphic operation as described above by following the arithmetic procedure P, thereby generating the encryption operation result. Note that the encryption operation result in the case in which homomorphic multiplication has not been performed even once is represented as (t1, t2) and the encryption operation result in the case in which homomorphic operation has been performed even once is represented as (T1, T2, T3).

Note that in the description of the homomorphic operation described above, a process method has been described with the encryption data encrypted with the user public key taken as a target. However, when homomorphic operation is performed by the administrator, homomorphic operation is possible also for encryption data c0 encrypted by using the master public key. Here, the process method is changed so that c0 is equated with c2 and only c2″ is generated in homomorphic addition. Alternatively, the process method is changed so that only C3 is generated in homomorphic multiplication. Still alternatively, the process method is changed so that only C3″ is generated in homomorphic addition after homomorphic operation.

Also, homomorphic operation can be performed also on the encryption data c0 encrypted with the master public key and the encryption data (c1, c2) encrypted with the user public key. Also here, the process method is changed as described above. That is, a change is made so that c0 is equated with c2 and the encryption data of the homomorphic operation result is represented in the form of c2″, C3, or C3″. However, the encryption operation result generated from a set of encryption data c0 or the encryption operation result generated in the form of c0 and (c1, c2) being mixed can be decrypted only by the administrator permitted to use the master decryption device 500. Note that as for this encryption operation result that can be decrypted only by the administrator, the encryption operation result in the case in which homomorphic multiplication has not been performed even once is represented by s and the encryption operation result in the case in which homomorphic operation has been performed even once is represented by S.

The output unit 705 outputs the encryption operation result received from the arithmetic operation unit 704 for transmission to the master decryption device 500 or the user decryption device 600 via the communication device 950.

Also, the output unit 705 outputs the encryption data received from the data save unit 703 for transmission to the master decryption device 500 or the user decryption device 600 via the communication device 950.

Next, description is made to hardware of each of the devices, that is, the master key generation device 200, the user key generation device 300, the encryption device 400, the master decryption device 500, the user decryption device 600, and the administration device 700, included in the encryption system 100.

The processor 910 is connected to other pieces of hardware via signal lines to control these other pieces of hardware. The processor 910 is an IC (Integrated Circuit) for performing processing. The processor 910 is also referred to as a CPU (Central Processing Unit), processing device, arithmetic device, microprocessor, microcomputer, or DSP (Digital Signal Processor).

The storage device 920 includes an auxiliary storage device 922 and a memory 921. The auxiliary storage device 922 is, specifically, a ROM (Read Only Memory), flash memory, or HDD (Hard Disk Drive). The memory 921 is, specifically, a RAM (Random Access Memory). The storage unit of each device may be implemented by the auxiliary storage device 922, may be implemented by the memory 921, or may be implemented by the memory 921 and the auxiliary storage device 922. Any method of implementing the storage unit can be taken.

The input interface 930 is a port connected to an input device such as a mouse, keyboard, or touch panel. The input interface 930 is, specifically, a USB (Universal Serial Bus) terminal. Note that the input interface 930 may be a port connected to a LAN (Local Area Network).

The output interface 940 is a port to which a cable of a display device such as a display is connected. The output interface 940 is, for example, a USB terminal or HDMI (registered trademark) (High Definition Multimedia Interface) terminal. The display is, specifically, an LCD (Liquid Crystal Display).

The communication device 950 includes a receiver which receives data and a transmitter which transmits data. The communication device 950 is, specifically, a communication chip or NIC (Network Interface Card). The receiver functions as a reception unit which receives data, and the transmitter functions as a transmission unit which transmits data.

The auxiliary storage device 922 has stored therein a program for implementing the function of the “unit” of each device of the encryption system 100. This program is loaded onto a memory, is read into the processor 910, and is executed by the processor 910. In the auxiliary storage device 922, an OS (Operating System) is also stored. At least part of the OS is loaded onto a memory, and the processor 910 executes the program for implementing the function of the “unit” while executing the OS.

Each device of the encryption system 100 may include only one processor 910 or may include a plurality of processors 910. A plurality of processors 910 may perform a program for implementing the function of the “unit” in a cooperative manner.

Information, data, signal values, and variable values indicating the result of the process of the “unit” are stored in a register or cache memory in the auxiliary storage device, memory, or the processor 910.

A program for implementing the function of the “unit” may be stored in a portable recording medium such as a magnetic disc, flexible disc, optical disc, compact disc, Blu-ray (registered trademark) disc, or DVD (Digital Versatile Disc).

Note that an encryption program 520 is a program for implementing the function described as the “unit” of each device of the encryption system 100. Also, one referred to as an encryption program product is a storage medium and storage device having the program for implementing the function described as the “unit” recorded therein, and has a computer-readable program loaded thereto, irrespective of outer appearance form.

***Description of Operation***

Next, an encryption process S100 by an encryption method 510 and the encryption program 520 in the encryption system 100 according to the present embodiment is described.

<Master Key Pair Generation and Save Process>

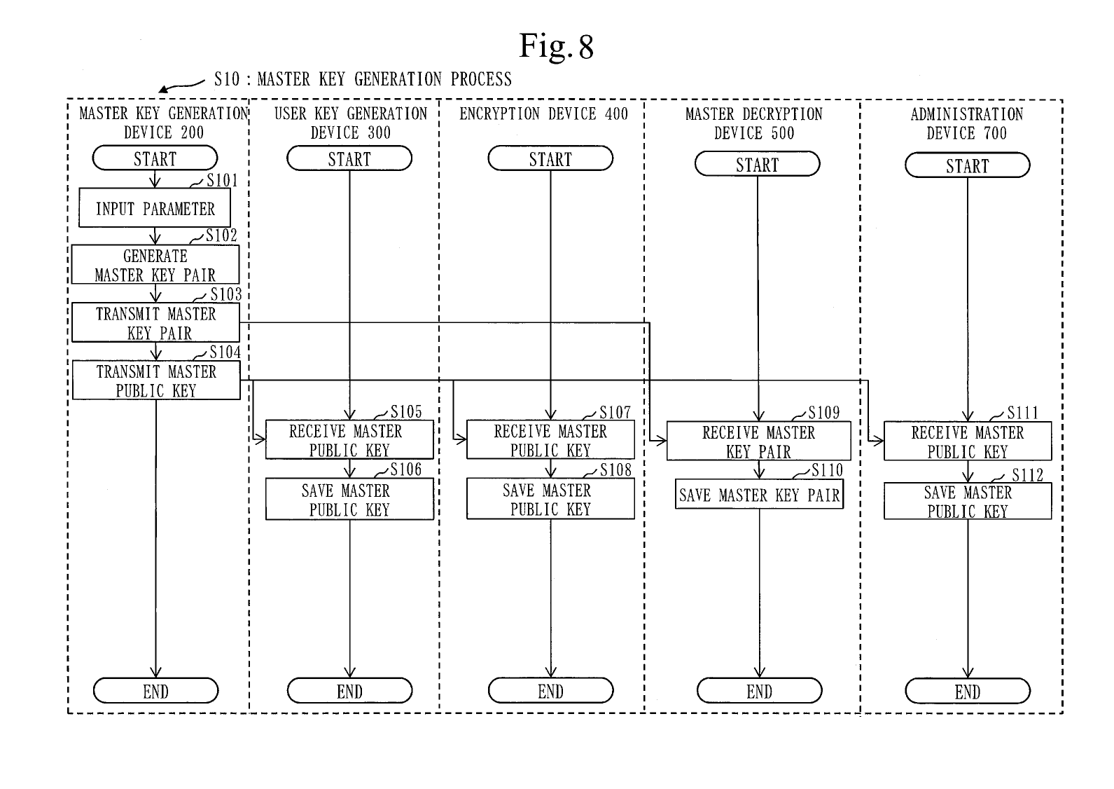

FIG. 8 is a flowchart illustrating a master key pair generation and save process of the encryption system 100 according to the present embodiment.

Step S101 to step S112 of FIG. 8 are processes to be performed by the master key generation device 200, the user key generation device 300, the encryption device 400, the master decryption device 500, and the administration device 700. Step S101 to step S104 are a master key generation process S10 to be performed by the master key generation device 200. Step S105 and step S106 are performed by the user key generation device 300. Step S107 and step S108 are performed by the encryption device 400. Step S109 and step S110 are performed by the master decryption device 500. Step S111 and step S112 are performed by the administration device 700.

At step S101, the input unit 201 receives the security parameter λ indicating encryption strength from the administrator.

At step S102, the master key generation unit 202 generates, based on the security parameter λ received from the input unit 201, a master key pair (MPK, MSK) formed of the master public key MPK and the master secret key MSK.

At step S103, the output unit 203 transmits the master key pair (MSK, MSK) generated at the master key generation unit 202 to the master decryption device 500.

At step S104, the output unit 203 transmits the master public key MPK generated at the master key generation unit 202 to the user key generation device 300, the encryption device 400, and the administration device 700. Here, only the master public key MPK is transmitted, and the master secret key MSK is not transmitted.

At step S105, the input unit 301 receives the master public key MPK generated at the master key generation device 200.

At step S106, the master public key save unit 302 saves the master public key MPK received from the input unit 301.

At step S107, the input unit 401 receives the master public key MPK generated at the master key generation device 200.

At step S108, the master public key save unit 402 saves the master public key MPK received from the input unit 401.

At step S109, the input unit 501 receives the master key pair (MPK, MSK) generated at the master key generation device 200.

At step S110, the master key pair save unit 502 saves the master key pair (MPK, MSK) received from the input unit 501. If required, to prevent the master secret key MSK from being leaked outside, the master key pair save unit 502 encrypts and saves the master secret key MSK. Alternatively, the master key pair save unit 502 saves the master secret key MSK together with authentication information so as to permit only the administrator to handle the master secret key MSK.

At step S111, the input unit 701 receives the master public key MPK generated at the master key generation device 200.

At step S112, the public key save unit 702 saves the master public key MPK received from the input unit 701.

With step S112, the master key pair generation and save process of the encryption system 100 ends.

<User Key Pair Generation and Save Process>

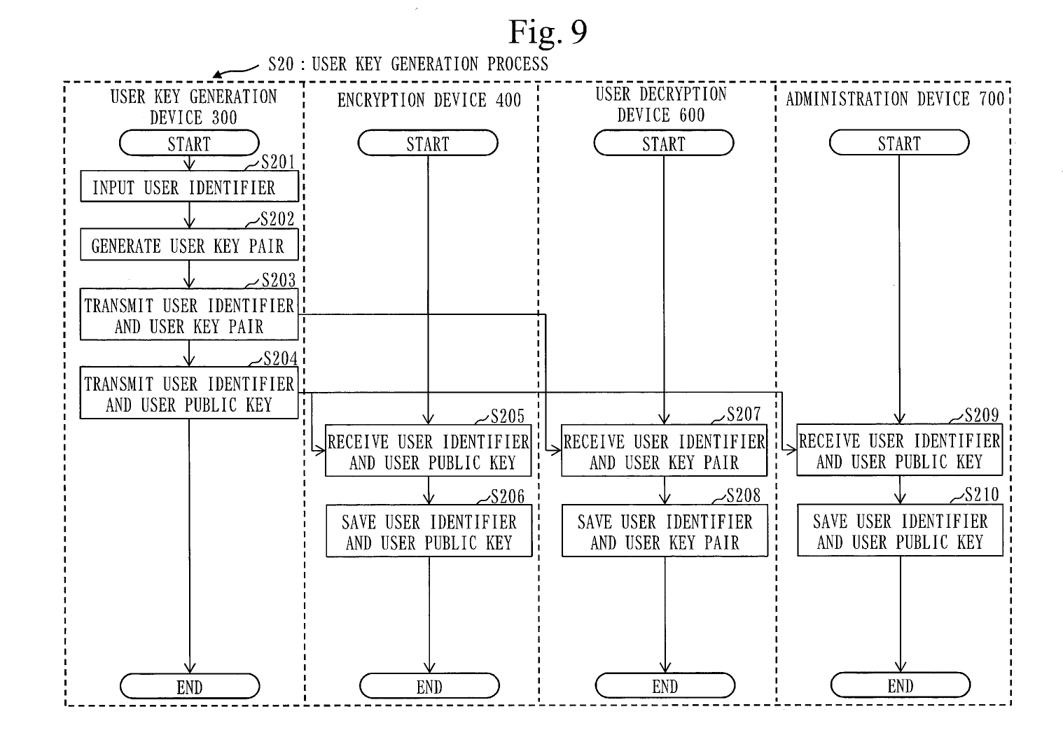

FIG. 9 is a flowchart illustrating a user key pair generation and save process of the encryption system 100 according to the present embodiment.

Step S201 to step S210 of FIG. 9 are processes to be performed by the user key generation device 300, the encryption device 400, the user decryption device 600, and the administration device 700. Step S201 to step S204 are a user key generation process S20 to be performed by the user key generation device 300. Step S205 and step S206 are performed by the encryption device 400. Step S207 and step S208 are performed by the user decryption device 600. Step S209 and step S210 are performed by the administration device 700.

At step S201, the input unit 301 receives, from the user, a user identifier UID for identifying that user.

At step S202, the user key generation unit 303 generates a user key pair formed of the user public key PK and the user secret key SK, (PK, SK), by using the user identifier UID received from the input unit 301 and the master public key MPK read from the master public key save unit 302.

At step S203, the output unit 304 outputs a set of the user key pair generated at the user key generation unit 303 and the user identifier, (PK, SK, UID), for transmission to the user decryption device 600.

At step S204, the output unit 304 outputs a pair of the user public key generated at the user key generation unit 303 and the user identifier, (PK, UID), for transmission to the encryption device 400 and the administration device 700. Here, the user secret key SK is not transmitted.

At step S205, the input unit 401 receives the pair of the user public key generated at the user key generation device 300 and the user identifier, (PK, UID).

At step S206, the user public key save unit 403 saves the pair of the user public key and the user identifier, (PK, UID), received from the input unit 401.

At step S207, the input unit 601 receives a set of the user key pair generated at the user key generation device 300 and the user identifier, (PK, SK, UID).

At step S208, the user key pair save unit 602 saves the set of the user key pair and the user identifier, (PK, SK, UID), received from the input unit 601. If required, the user key pair save unit 602 encrypts and saves the user secret key SK so that the user secret key SK is not leaked outside. Alternatively, to limit a user who can handle the user secret key SK, the user key pair save unit 602 saves the user secret key SK together with authentication information.

At step S209, the input unit 701 receives a pair of the user public key generated at the user key generation device 300 and the user identifier, (PK, UID).

At step S210, the public key save unit 702 saves the pair of the user public key and the user identifier, (PK, UID).

With step S210, the user key pair generation and save process of the encryption system 100 ends.

<Data Encryption and Save Process>

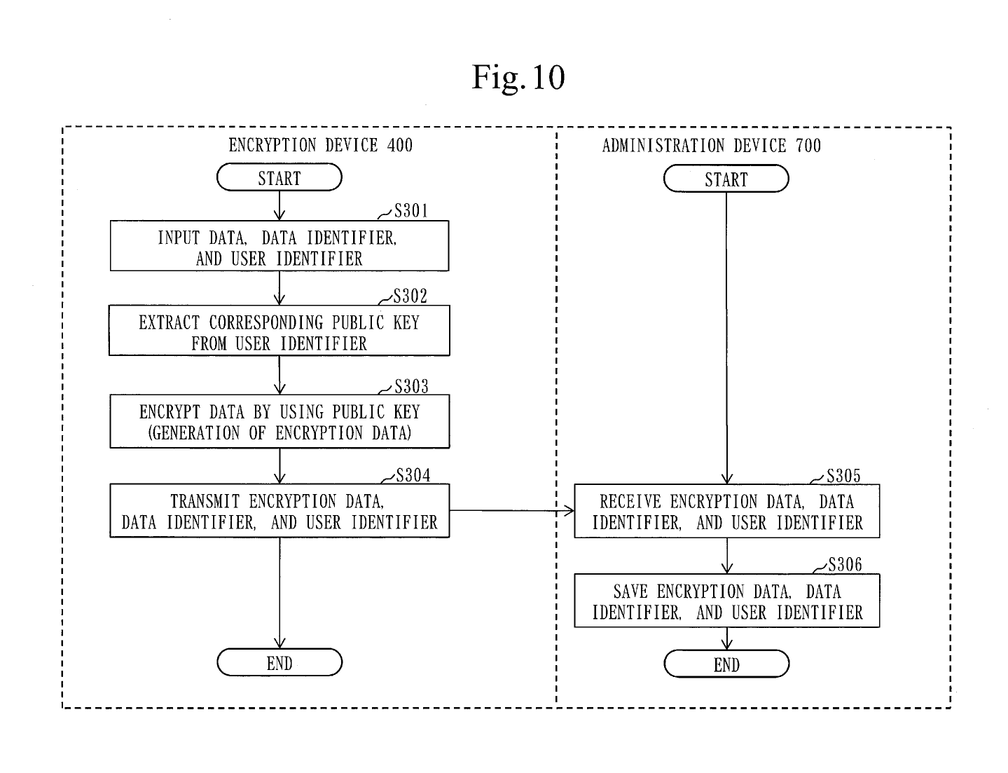

FIG. 10 is a flowchart illustrating a data encryption and save process of the encryption system 100 according to the present embodiment.

Step S301 to step S306 of FIG. 10 are processes to be performed by the encryption device 400 and the administration device 700. Step S301 to step S304 are performed by the encryption device 400. Step S305 and step S306 are processes to be performed by the administration device 700.

At step S301, the input unit 401 receives, from the user, the data m to be encrypted, the data identifier DID for identifying that data, and the user identifier UID for identifying the user to which the encryption data is to be passed.

At step S302, the encryption unit 404 reads, from the user public key save unit 403, a pair of the user public key and the user identifier, (PK, UID) corresponding to the user identifier UID received from the input unit 401. If UID=ADMIN, the encryption unit 404 reads the master public key MPK from the master public key save unit 402.

At step S303, the encryption unit 404 encrypts, in the manner as described above, the data m received from the input unit 401 by using the user public key PK read at step S302, and generates encryption data (c1, c2). If the master public key MPK is read at step S302, the encryption unit 404 encrypts, in the manner as described above, the data m received from the input unit 401 and generates encryption data c0.

At step S304, the transmission unit 405 outputs a set of the user identifier UID, the data identifier DID, and the encryption data (c1, c2) generated at step S303, (UID, DID, c1, c2), for transmission to the administration device 700. If the encryption data c0 is generated at step S303, the transmission unit 405 outputs a set of the user identifier UID=ADMIN, the data identifier DID, and the encryption data c0 generated at step S303, (ADMIN, DID, c0), for transmission to the administration device 700.

At step S305, the input unit 701 receives the set of the user identifier, the data identifier, and the encryption data, (UID, DID, c1, c2) or (ADMIN, DID, c0), transmitted from the encryption device 400 at step S304.

At step S306, the data save unit 703 saves the set of the user identifier, the data identifier, and the encryption data, (UID, DID, c1, c2) or (ADMIN, DID, c0), received by the input unit 701 at step S305.

With step S306, the data encryption and save process of the encryption system 100 ends.

<Master Decryption Process S30>

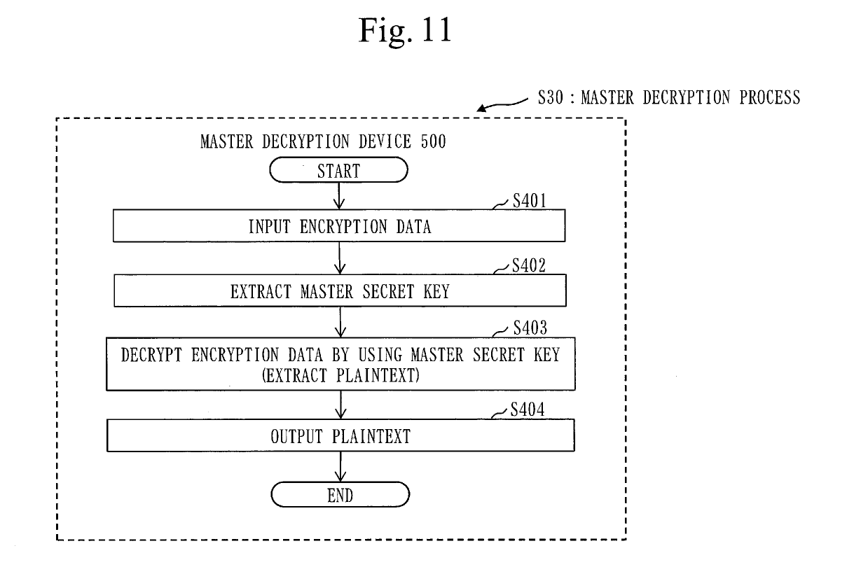

FIG. 11 is a flowchart illustrating a master decryption process S30 of the encryption system 100 according to the present embodiment. The master decryption process S30 is a data decryption process for the administrator in which the encryption operation result is acquired and the acquired encryption operation result is decrypted with the master secret key MSK.

Step S401 to step S404 of FIG. 11 are processes to be performed by the master decryption device 500.

At step S401, the input unit 501 receives the encryption data c0 or (c1, c2) saved in the administration device 700 or the like.

At step S402, the decryption unit 504 reads the master key pair (MPK, MSK) from the master key pair save unit 502. If required, the decryption unit 504 authenticates the administrator with an input of a password, token, biological information, or the like.

At step S403, the decryption unit 504 performs a decryption process as described above on the encryption data c0 or (c1, c2) received by the input unit 501 at step S401, and finds data M. The data M is also referred to as plaintext.

At step S404, the output unit 505 outputs the data M generated by the decryption unit 504 at step S403.

With step S404, the master decryption process S30 of the encryption system 100 ends.

<User Decryption Process S40>

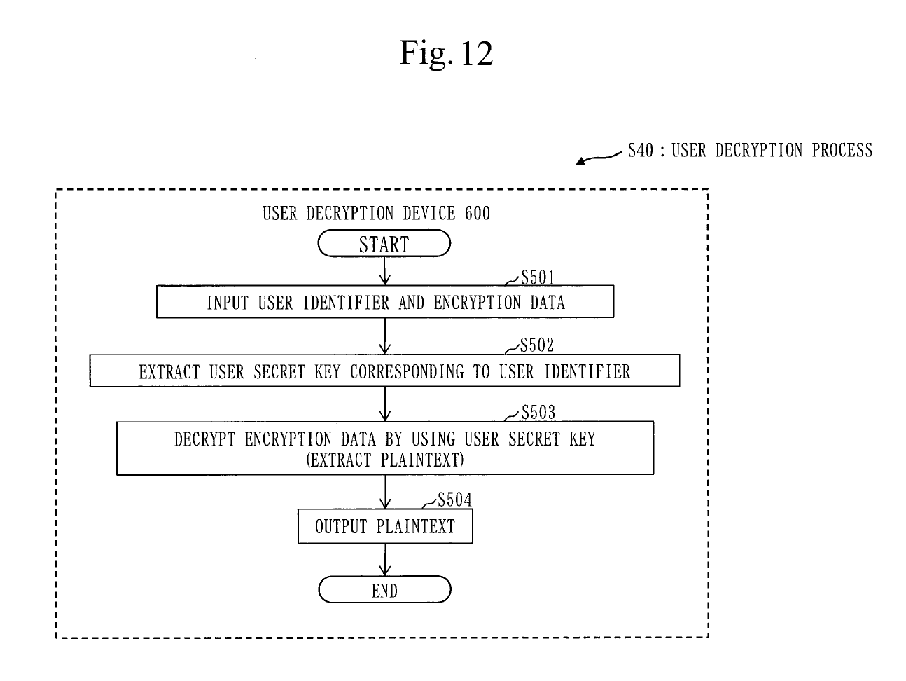

FIG. 12 is a flowchart illustrating a user decryption process S40 of the encryption system 100 according to the present embodiment. The user decryption process S40 is a data decryption process for the user in which the encryption operation result is acquired from the administration device 700 and the acquired encryption operation result is decrypted with the user secret key SK.

Step S501 to step S504 of FIG. 12 are processes to be performed by the user decryption device 600.

At step S501, the input unit 601 receives the user identifier UID indicating a user key pair for use in decryption and the encryption data (c1, c2) saved in the administration device 700 or the like.

At step S502, the decryption unit 604 reads a set of the user key pair and the user identifier, (PK, SK, UID), from the user key pair save unit 602 based on the user identifier UID received by the input unit 601 at step S501. If required, the decryption unit 604 authenticates the user with an input of a password, token, biological information, or the like.

At step S503, the decryption unit 604 performs a decryption process as described above on the encryption data (c1, c2) received by the input unit 601 at step S501, and finds data M. The data M is also referred to as plaintext.

At step S504, the output unit 605 outputs the data M generated by the decryption unit 604 at step S503.

With step S504, the user decryption process S40 of the encryption system 100 ends.

<Homomorphic Operation Process S50 and Operation Result Decryption Process S60 for Administrator>

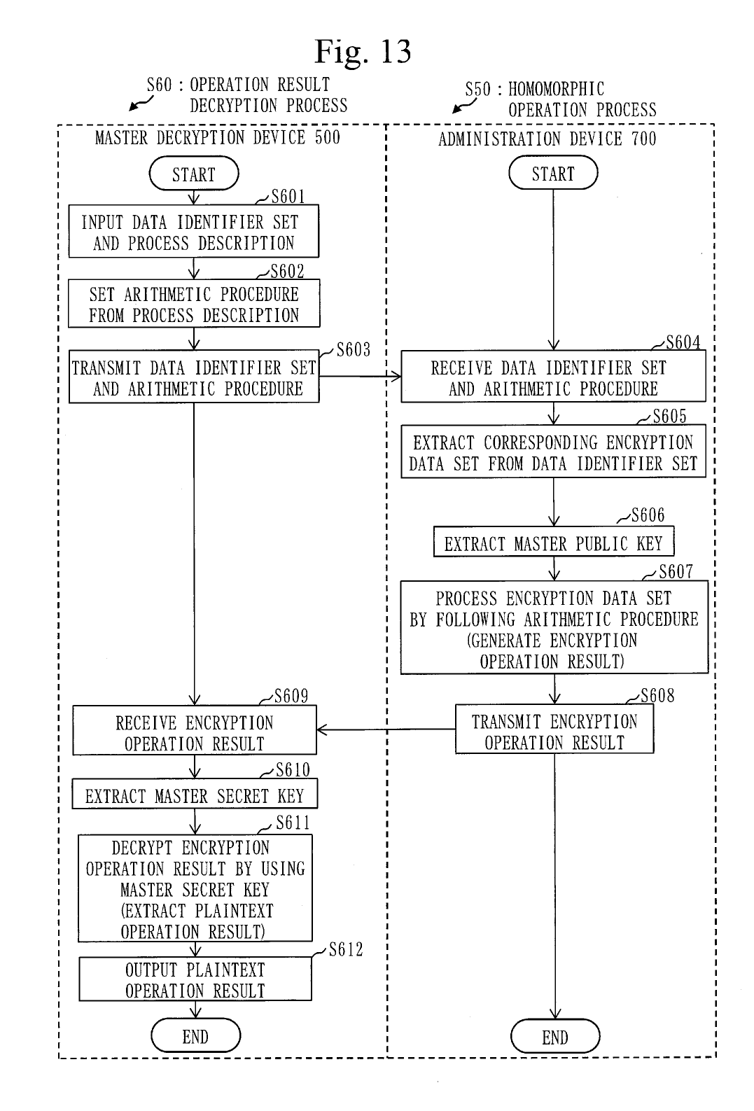

FIG. 13 is a flowchart illustrating a homomorphic operation process S50 and an operation result decryption process S60 of the encryption system 100 according to the present embodiment. In FIG. 13, the homomorphic operation process S50 and the operation result decryption process S60 for the administrator are described.

Step S601 to step S612 of FIG. 13 are processes to be performed by the master decryption device 500 and the administration device 700. Step S601 to step S603 and step S609 to step S612 are processes to be performed by the master decryption device 500. Step S604 to step S608 are processes to be performed by the administration device 700.

At step S601, the input unit 501 receives, from the administrator, the data identifier set {DID} for identifying data as a target for homomorphic operation in the encryption data saved in the administration device 700 and the process description K indicating how the data as the target for homomorphic operation is to be processed.

At step S602, the arithmetic procedure setting unit 503 generates, in the manner as described above, the arithmetic procedure P from the data identifier set {DID} and the process description K received by the input unit 501 at step S601.

At step S603, the output unit 505 outputs a set of the administrator's user identifier ADMIN, the data identifier set {DID}, and the arithmetic procedure P generated by the arithmetic procedure setting unit 503 at step S602, (ADMIN, {DID}, P), for transmission to the administration device 700.

At step S604, the input unit 701 receives the set of the user identifier, the data identifier set, and the arithmetic procedure, (ADMIN, {DID}, P), transmitted by the master decryption device 500 at step S603.

At step S605, the arithmetic operation unit 704 reads, from the data save unit 703, a set (ADMIN, DID, c0) or (UID, DID, c1, c2) having the data identifier DID included in {DID} by using (ADMIN, {DID}, P) received by the input unit 701 at step S604.

At step S606, the arithmetic operation unit 704 reads the master public key MPK from the public key save unit 702.

At step S607, the arithmetic operation unit 704 performs a homomorphic operation process, in the manner as described above by following the arithmetic procedure P, on the set of the encryption data c0 or (c1, c2) read at step S605 by using the master public key MPK read at step S606, and generates the encryption operation result s or S.

At step S608, the output unit 705 outputs the encryption operation result s or S generated by the arithmetic operation unit 704 at step S607 for transmission to the master decryption device 500.

At step S609, the input unit 501 receives the encryption operation result s or S transmitted by the administration device 700 at step S608.

At step S610, the decryption unit 504 reads the master key pair (MPK, MSK) from the master key pair save unit 502. If required, the decryption unit 504 also authenticates the administrator with an input of a password, token, biological information, or the like.

At step S611, the decryption unit 504 finds data M as the plaintext operation result by following the above-described decryption process on the encryption operation result s or S received by the input unit 501 at step S609, by using the master key pair (MPK, MSK) read at step S610.

At step S612, the output unit 505 outputs the data M found by the decryption unit 504 at step S611.

With step S612, the homomorphic operation process and its decryption process for the administrator of the encryption system 100 ends.

<Homomorphic Operation Process S50 and Operation Result Decryption Process S60 for User>

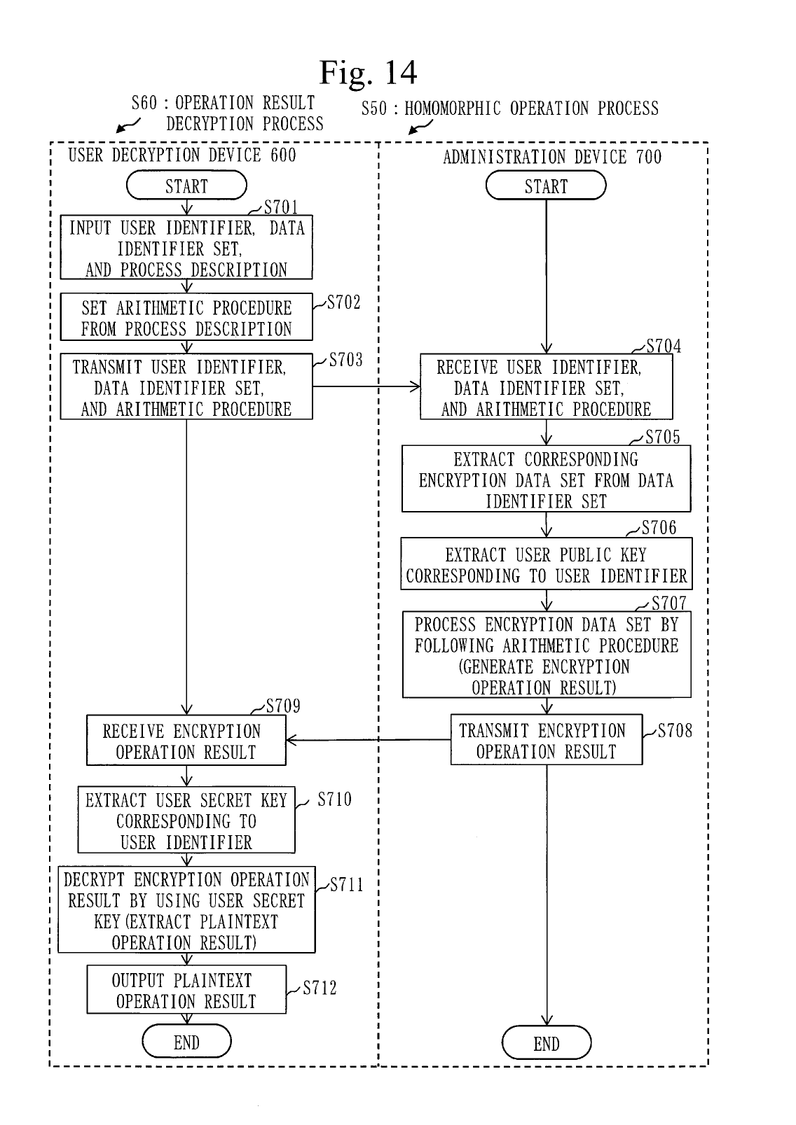

FIG. 14 is a flowchart illustrating a homomorphic operation process S50 and an operation result decryption process S60 of the encryption system 100 according to the present embodiment. In FIG. 14, the homomorphic operation process S50 and the operation result decryption process S60 for the user are described.

Step S701 to step S712 of FIG. 14 are processes to be performed by the user decryption device 600 and the administration device 700. Step S701 to step S703 and step S709 to step S712 are processes to be performed by the user decryption device 600.

Step S704 to step S708 are processes to be performed by the administration device 700.

At step S701, the input unit 601 receives, from the user, the user identifier UID, the data identifier set {DID} for identifying data as a target for homomorphic operation in the encryption data saved in the administration device 700, and the process description K indicating how the target data is to be processed.

At step S702, the arithmetic procedure setting unit 603 generates the arithmetic procedure P in the manner as described above from the data identifier set {DID} and the process description received by the input unit 601 at step S701.

At step S703, the output unit 605 outputs a set of the user identifier UID, the data identifier set {DID}, and the arithmetic procedure P generated by the arithmetic procedure setting unit 603 at step S702, (UID, {DID}, P), for transmission to the administration device 700.

At step S704, the input unit 701 receives the set of the user identifier, the data identifier set, and the arithmetic procedure, (UID, {DID}, P), transmitted by the user decryption device 600 at step S703.

At step S705, the arithmetic operation unit 704 reads a set (UID, DID, c1, c2) corresponding to the pair (UID, DID1), (UID, DIDn) from the data save unit 703 by using (UID, {DID}, P) received by the input unit 701 at step S704.

Here, if the encryption data c0 encrypted with the master public key or the encryption data (c1, c2) encrypted with the user public key different from UID of the specified user is tried to be read, that is, if a set satisfying UID≠UID′ and (UID′, DIDi, c1, c2) (where DIDi∈{DID} and 1≤i≤n} is tried to be read, the encryption operation result cannot be decrypted, or the decryption result is random data. Thus, in this case, the arithmetic operation unit 704 generates a special character string such as “error” as the encryption operation result.

At step S706, the arithmetic operation unit 704 reads a pair of the user public key and the user identifier, (PK, UID), from the public key save unit 702 by using (UID, {DID}, P) received by the input unit 701 at step S704.

At step S707, the arithmetic operation unit 704 performs a homomorphic operation process, in the manner as described above by following the arithmetic procedure P, on the set of the encryption data (c1, c2) read at step S705 by using the public key PK read at step S706, and generates the encryption operation result (t1, t2) or (T1, T2, T3). If the arithmetic operation unit 704 generates the special character string “error” at step S705, the arithmetic operation unit 704 performs no process here.

At step S708, the output unit 705 outputs the encryption operation result (t1, t2) or (T1, T2, T3) generated by the arithmetic operation unit 704 at step S707 or the special character string “error” for transmission to the user decryption device 600.

At step S709, the input unit 601 receives the encryption operation result (t1, t2) or (T1, T2, T3) or the special character string “error” transmitted by the administration device 700 at step S708.

At step S710, the decryption unit 604 reads a set of the user key pair and the user identifier, (PK, SK, UID), from the user key pair save unit 602. If required, the decryption unit 604 also authenticates the user with an input of a password, token, biological information, or the like. If the input unit 601 receives the special character string “error” at step S709, the decryption unit 604 performs no process here.

At step S711, the decryption unit 604 finds data M as the plaintext operation result by following the above-described decryption process on the encryption operation result (t1, t2) or (T1, T2, T3) received by the input unit 601 at step S709, by using the user key pair (PK, SK) read at step S710. If the input unit 601 receives the special character string “error” at step S709, the decryption unit 604 performs no process here.

At step S712, the output unit 605 outputs the data M found by the decryption unit 604 at step S711. If the input unit 601 receives the special character string “error” at step S709, the output unit 605 outputs the special character string “error”.

With step S712, the homomorphic operation process and its decryption process for the user of the encryption system 100 ends.

***Other Structures***

The function of each device of the encryption system 100 is implemented by software in the present embodiment, but, as a modification example, the function of each device of the encryption system 100 may be implemented by hardware.

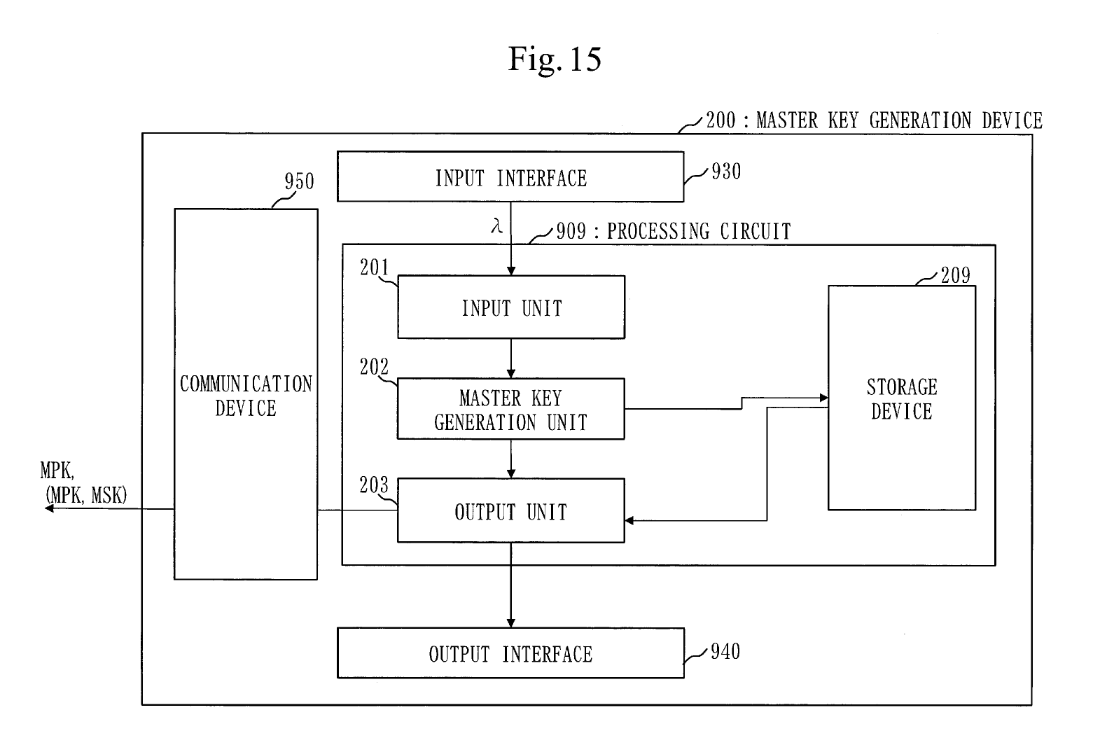

This modification example of the present embodiment is described by using FIG. 15 to FIG. 20.

FIG. 15 is a diagram illustrating the structure of the master key generation device 200 according to the modification example of the present embodiment.

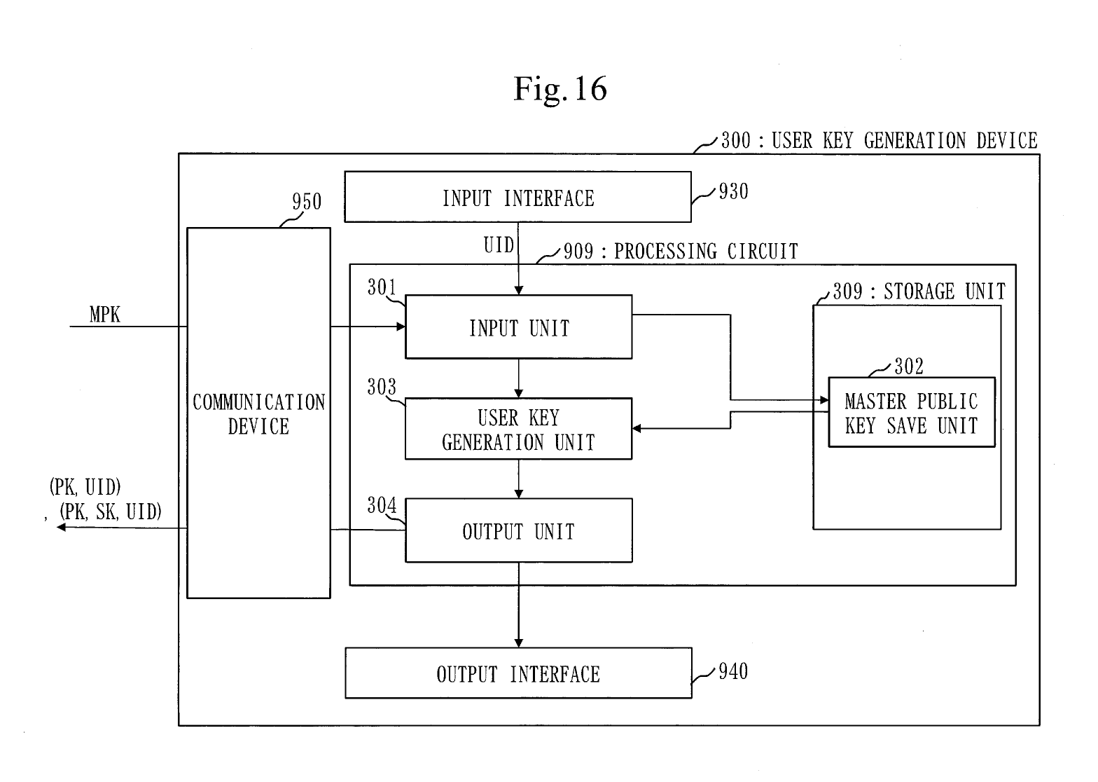

FIG. 16 is a diagram illustrating the structure of the user key generation device 300 according to the modification example of the present embodiment.

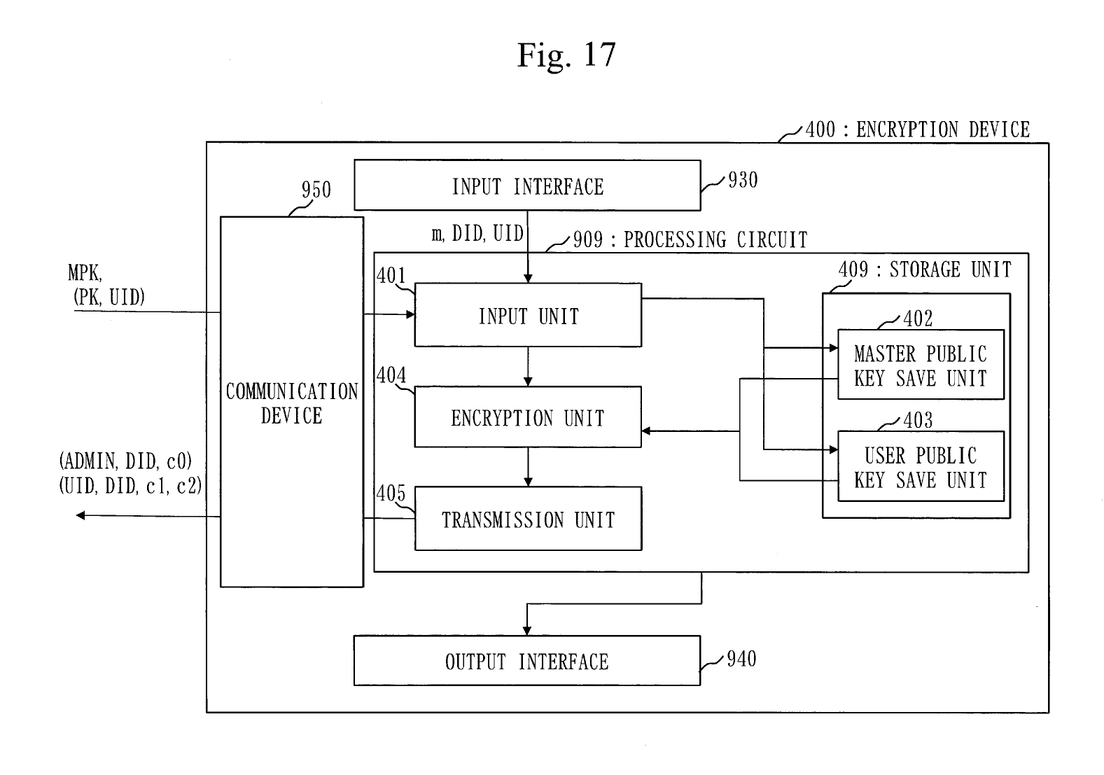

FIG. 17 is a diagram illustrating the structure of the encryption device 400 according to the modification example of the present embodiment.

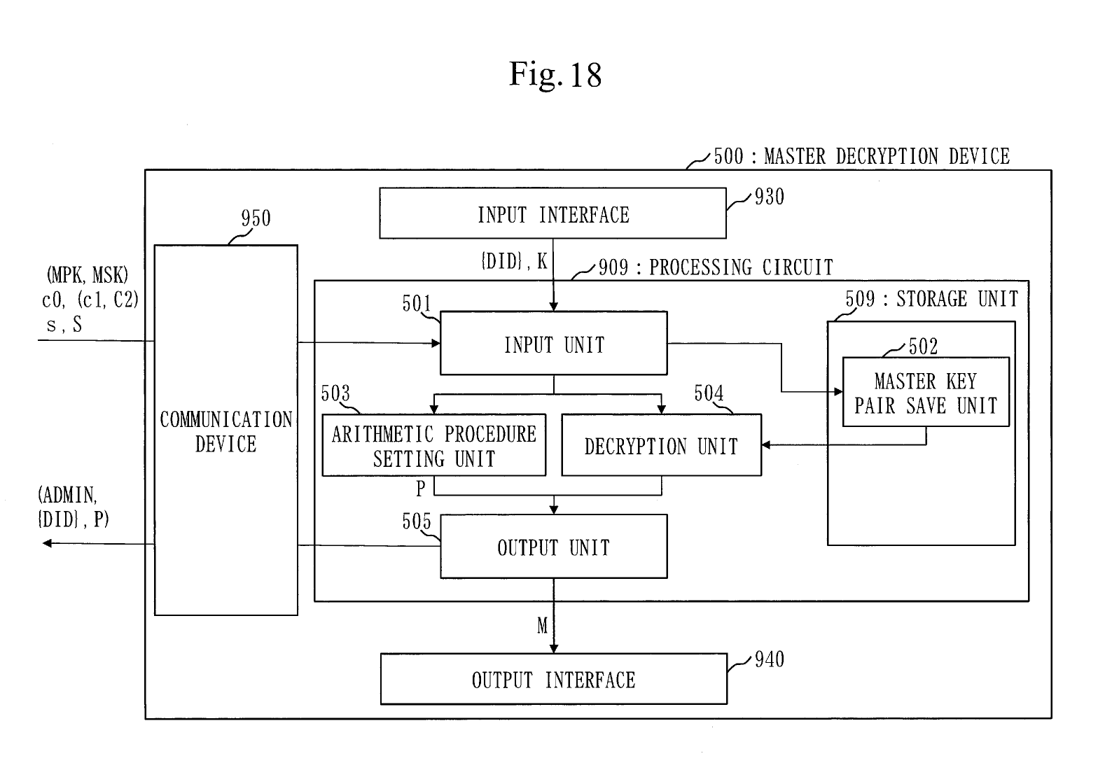

FIG. 18 is a diagram illustrating the structure of the master decryption device 500 according to the modification example of the present embodiment.

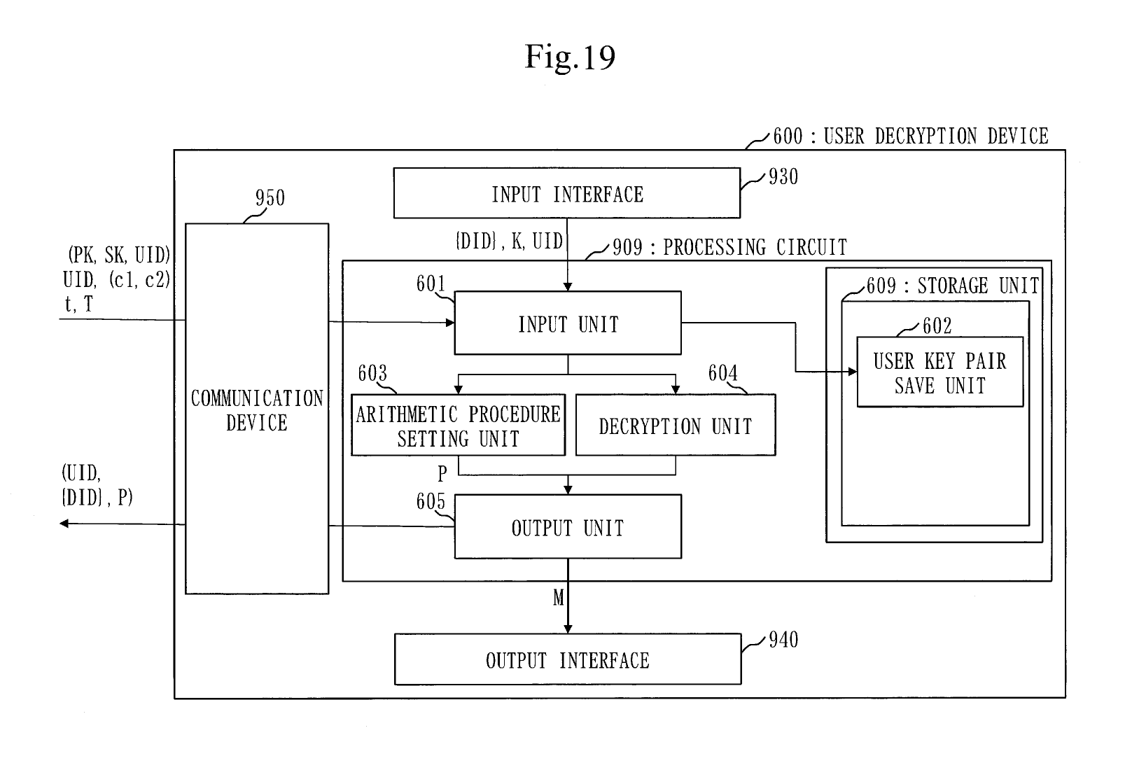

FIG. 19 is a diagram illustrating the structure of the user decryption device 600 according to the modification example of the present embodiment.

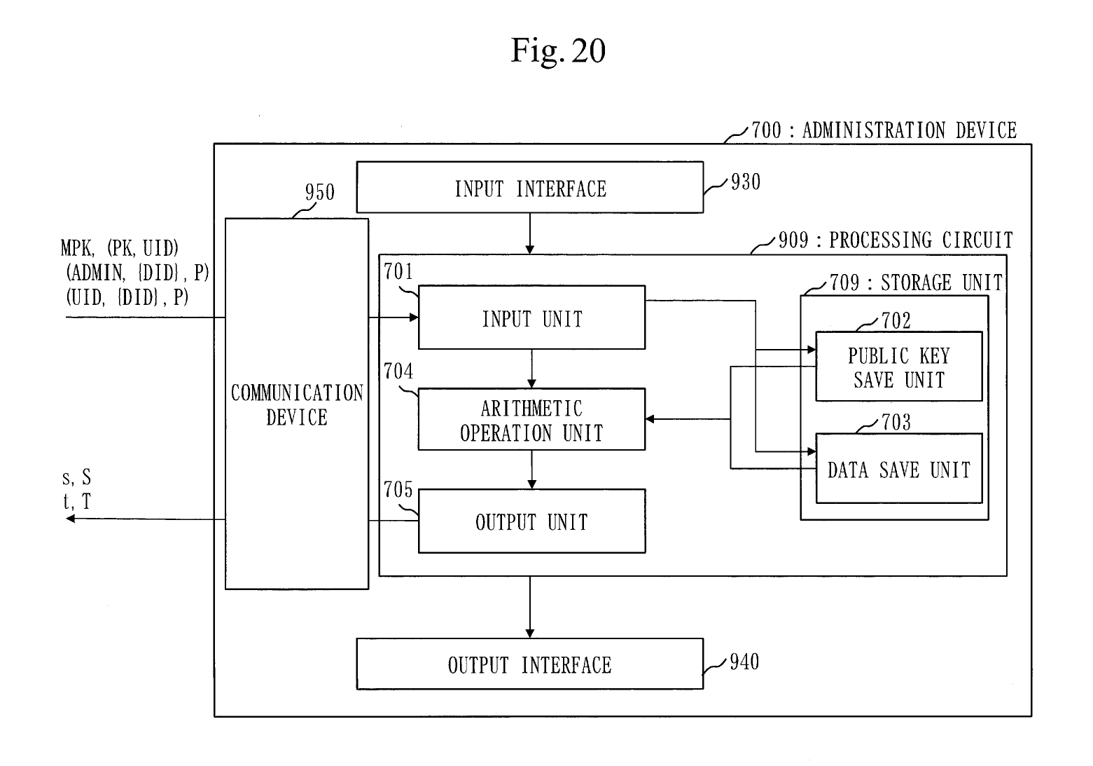

FIG. 20 is a diagram illustrating the structure of the administration device 700 according to the modification example of the present embodiment.

As illustrated in FIG. 15 to FIG. 20, each device of the encryption system 100 includes a processing circuit 909 in place of the processor 910 and the storage device 920.

The processing circuit 909 is a dedicated electronic circuit for implementing the functions of the “units” of each device and the storage unit of each device described above. The processing circuit 909 is, specifically, a single circuit, composite circuit, programmed processor, parallel-programmed processor, logic IC, GA (Gate Array), ASIC (Application Specific Integrated Circuit), or FPGA (Field-Programmable Gate Array).

Each device of the encryption system 100 may include a plurality of processing circuits in place of the processing circuit 909. With the plurality of these processing circuits, the functions of the “units” are implemented as a whole. Each processing circuit is a dedicated electronic circuit, like the processing circuit 909.

As another modification example, the function of each device of the encryption system 100 may be implemented by a combination of software and hardware. That is, in each device of the encryption system 100, a part of the functions may be implemented by dedicated hardware and the remaining functions may be implemented by software.

The processor 910, the storage device 920, and the processing circuit 909 are collectively referred to as “processing circuitry”. That is, if the structure of each device of the encryption system 100 is any of the structures illustrated in FIG. 2 to FIG. 7 and FIG. 15 to FIG. 20, the functions of the “units” and the storage unit are implemented by the processing circuitry.

The “units” may be read as “steps”, “procedures”, or “processes”. Also, the functions of the “units” may be implemented by firmware. That is, the functions of the “units” of each device of the encryption system 100 are implemented by software, firmware, or a combination of software and firmware.

### Description of Effects of Present Embodiment

As described above, according to the encryption system of the present embodiment, the user public key PK can be generated from the master public key MPK as public information without using the master secret key MSK, which requires strict administration, at all. This can reduce operation cost.

Also, according to the encryption system of the present embodiment, the administrator (first user) and the user (second user) can decrypt one ciphertext. This can reduce save cost.

Furthermore, according to the encryption system of the present embodiment, the encryption system is not based on lattice encryption but on pairing-based cryptography. This allows a reduction of the key size or the ciphertext size and efficient processing. Also, since not only homomorphic addition but also homomorphic multiplication can be performed, the system has high homomorphy.

Still further, according to the encryption system of the present embodiment, different encryption data is generated every time even if the same data is saved. This makes the encryption system resistant to frequency analysis attacks and so forth.

Yet further, according to the encryption system of the present embodiment, the data is saved as encrypted. Thus, even if the encryption data is leaked from the administration device, the contents of the saved data are not known. Also, since data processing can be performed as the data is kept encrypted, the contents of the data are not known from the encryption data.

Yet further, according to the encryption system of the present embodiment, the efficiency-enhancing scheme of converting composite-order groups to prime-order groups in Non-Patent Literature 7 can be directly applied. This can achieve a more efficient homomorphic encryption technique.

Yet further, in the present embodiment, description is made to the case in which, in the encryption system, each of the master key generation device 200, the user key generation device 300, the encryption device 400, the master decryption device 500, the user decryption device 600, and the administration device 700 is one device and a computer. However, any of the master key generation device 200, the user key generation device 300, the encryption device 400, the master decryption device 500, the user decryption device 600, and the administration device 700 may be simultaneously included in the same computer (for example PC (Personal Computer)). For example, the master decryption device 500, the user decryption device 600, and the encryption device 400 may be included in one PC. Note that the administration device 700 is preferably an independent device. Also, the master key generation device 200 and the user key generation device 300 are preferably separate devices. However, any combination of the respective devices in the encryption system is possible to configure the encryption system as long as the functions described in the above-described embodiment can be implemented.

Yet further, in each device of the encryption system, any one of those described as “units” may be adopted, or any combination of some of those may be adopted. That is, any functional blocks of each device in the encryption system capable of implementing the functions described in the above-described embodiment can be adopted. Any combination of these functional blocks is possible to configure each device. Also, any block structure of these functional blocks is possible to configure each device.

Also in the present embodiment, a plurality of components may be partially combined for implementation. Alternatively, one invention in the present embodiment may be partially implemented. In addition, the present embodiment may be wholly or partially implemented in any combination.

Note that the above-described embodiment is a basically preferable example, is not intended to restrict the present invention, applications thereof, or its range of use, and can be variously modified as required.

### REFERENCE SIGNS LIST

100: encryption system; 101: Internet; 200: master key generation device; 201, 301, 401, 501, 601, 701: input unit; 202: master key generation unit; 203, 304, 505, 605, 705: output unit; 209, 309, 409, 509, 609, 709: storage unit; 300: user key generation device; 302: master public key save unit; 303: user key generation unit; 400: encryption device; 402: master public key save unit; 403: user public key save unit; 404: encryption unit; 405: transmission unit; 500: master decryption device; 502: master key pair save unit; 503: arithmetic procedure setting unit; 504: decryption unit; 600: user decryption device; 602: user key pair save unit; 603: arithmetic procedure setting unit; 604: decryption unit; 700: administration device; 702: public key save unit; 703: data save unit; 704: arithmetic operation unit; 510: encryption method; 520: encryption program; 909: processing circuit; 910: processor; 920: storage device; 930: input interface; 940: output interface; 950: communication device; 921: memory; 922: auxiliary storage device; S100: encryption process; S10: master key generation process; S20: user key generation process; S30: master decryption process; S40: user decryption process; S50: homomorphic operation process; S60: operation result decryption process; P: arithmetic procedure

1. An encryption system comprising:
a master key generation device to generate a public key and a secret key for a first user as a master public key and a master secret key;
a user key generation device to generate a public key and a secret key for a second user as a user public key and a user secret key by using the master public key;
an administration device including a data save memory to save encryption data encrypted with the user public key and an arithmetic operator to acquire a procedure of operation using data as an arithmetic procedure, to select encryption data which has been encrypted from data for use in the arithmetic procedure, from the data save memory, to perform homomorphic operation on the encryption data based on the arithmetic procedure, and to output an operation result of the homomorphic operation as an encryption operation result; and
a master decryption device to acquire the encryption operation result and to decrypt the acquired encryption operation result with the master secret key.

2. The encryption system according to claim 1, wherein
the master key generation device transmits the master public key and the master secret key to the master decryption device, and transmits only the master public key to the user key generation device and the administration device.

3. The encryption system according to claim 1, wherein
the master key generation device generates the master public key and the master secret key by using a generator configuring a cyclic group on an elliptic curve capable of calculating a pairing map, and
the user key generation device generates the user public key and the user secret key by using the master public key and a randomly-selected natural number.

4. The encryption system according to claim 1, wherein
the arithmetic operator acquires the arithmetic procedure including multiplication.

5. The encryption system according to claim 1, further comprising:
an encryption device to acquire data to be encrypted, to encrypt the acquired data with the user public key, and to transmit the encrypted data as the encryption data to the administration device; and
a user decryption device to acquire the encryption operation result from the administration device and to decrypt the acquired encryption operation result with the user secret key.

6. The encryption system according to claim 5, wherein
the master key generation device transmits the master public key and the master secret key to the master decryption device, and transmits only the master public key to the user key generation device, the encryption device and the administration device, and
the user key generation device transmits the user public key and the user secret key to the user decryption device, and transmits only the user public key to the encryption device and the administration device.

7. The encryption system according to claim 5, wherein
the encryption device acquires the data to be encrypted and a user identifier for identifying a user, and transmits the encryption data and the user identifier to the administration device,
the data save memory stores the encryption data and the user identifier in association with each other, and
the arithmetic operator acquires the arithmetic procedure and a second user identifier, which is a user identifier of the second user, selects, from the data save memory, encryption data which has been encrypted from data for use in the arithmetic procedure and is associated with the second user identifier, and performs the homomorphic operation on the selected encryption data based on the arithmetic procedure.

8. An encryption method comprising:
generating a public key and a secret key for a first user as a master public key and a master secret key;
generating a public key and a secret key for a second user as a user public key and a user secret key by using the master public key;
acquiring a procedure of operation using data as an arithmetic procedure, selecting encryption data which has been encrypted from data for use in the arithmetic procedure, from a data save memory to save encryption data encrypted with the user public key, performing homomorphic operation on the encryption data based on the arithmetic procedure, and outputting an operation result of the homomorphic operation as an encryption operation result; and
acquiring the encryption operation result and decrypting the acquired encryption operation result with the master secret key.

9. A non-transitory computer readable medium storing an encryption program that causes a computer to execute:
a master key generation process of generating a public key and a secret key for a first user as a master public key and a master secret key;
a user key generation process of generating a public key and a secret key for a second user as a user public key and a user secret key by using the master public key;
a homomorphic operation process of acquiring a procedure of operation using data as an arithmetic procedure, selecting encryption data which has been encrypted from data for use in the arithmetic procedure, from a data save memory to save encryption data encrypted with the user public key, performing homomorphic operation on the encryption data based on the arithmetic procedure, and outputting an operation result of the homomorphic operation as an encryption operation result; and
an operation result decryption process of acquiring the encryption operation result and decrypting the acquired encryption operation result with the master secret key.
